(19) United States
(12) Patent Application Publication
(10) Pub. No.: US 2026/0230206 A1
(43) Pub. Date: Aug. 6, 2026

(54) CONFLICT HANDLING BETWEEN LAYER 1 CROSS-LINK INTERFERENCE RESOURCES AND UPLINK OR DOWNLINK IN SUB-BAND FULL DUPLEX

(71) Applicant: QUALCOMM Incorporated, San Diego, CA (US)

(72) Inventors: Abdelrahman Mohamed IBRAHIM, San Diego, CA (US); Muhammad Sayed Khairy ABDELGHAFFAR, San Jose, CA (US); Qian ZHANG, Basking Ridge, NJ (US)

(21) Appl. No.: 19/405,804

(22) Filed: Dec. 2, 2025

Related U.S. Application Data
(60) Provisional application No. 63/754,926, filed on Feb. 6, 2025.

(51) Int. Cl. H04B 17/354; H04L 5/14

(52) U.S. Cl. CPC H04B 17/354; H04L 5/14

(57) ABSTRACT

Certain aspects of the present disclosure provide techniques for wireless communications. An example method includes receiving a configuration of a layer 1 (L1) cross-link interference (CLI) measurement resource in a sub-band full duplex (SBFD) time resource; receiving an indication of a communication that conflicts with the L1 CLI measurement resource; and performing a measurement on the L1 CLI measurement resource, performing the communication that conflicts with the L1 CLI measurement resource, or identifying an error case, based on a first configuration type of the L1 CLI measurement resource and a second configuration type of the communication.

### CROSS-REFERENCE TO RELATED APPLICATION(S)

The present Application for Patent claims benefit of U.S. Provisional Application No. 63/754,926, filed Feb. 6, 2025, which is hereby expressly incorporated by reference herein in its entirety.

### INTRODUCTION

### Field of the Disclosure

Aspects of the present disclosure relate to wireless communications, and more particularly, to techniques for conflict handling between Layer 1 cross-link interference resources and uplink or downlink in sub-band full duplex.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method for wireless communication by a user equipment (UE). The method includes receiving a configuration of a layer 1 (L1) cross-link interference (CLI) measurement resource in a sub-band full duplex (SBFD) time resource; receiving an indication of a communication that conflicts with the L1 CLI measurement resource; and performing a measurement on the L1 CLI measurement resource, performing the communication that conflicts with the L1 CLI measurement resource, or identifying an error case, based on a first configuration type of the L1 CLI measurement resource and a second configuration type of the communication.

Certain aspects provide a method for wireless communication by a UE. The method includes receiving a configuration of a L1 CLI measurement resource in a SBFD time resource, wherein the L1 CLI measurement resource conflicts with a synchronization signal block (SSB); and performing a measurement on the L1 CLI measurement resource, receiving the SSB, or identifying an error case, based on whether the UE supports simultaneous reception of the SSB and measurement of the L1 CLI measurement resource.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIGS. 5A, 5B, and 5C depict example configurations for full-duplex communications in accordance with aspects of the present disclosure.

FIG. 6 is a diagram illustrating an example 600 of SBFD activation, in accordance with the present disclosure

FIGS. 7A, 7B, and 7C depict examples of interference scenarios based on full-duplex communications

FIGS. 8-14 are diagrams illustrating examples of a conflict on an SBFD time resource.

FIGS. 15-18 depict process flows for communications in a network between a network entity and a UE.

FIG. 19 depicts a method for wireless communications.

FIG. 20 depicts another method for wireless communications.

FIG. 21 depicts aspects of an example communications device.

### DETAILED DESCRIPTION

Aspects of the present disclosure provide apparatuses, methods, processing systems, and computer-readable mediums for conflict handing for cross-link interference measurement.

A wireless communication network may include a number of devices and network entities employing techniques for exchanging information wirelessly. For example, a wireless communication network may include devices (e.g., user equipments (UEs)) and network entities (e.g., base stations (BSs), NodeBs, enhanced NodeBs (eNBs), next generation NodeBs (gNBs or gNodeBs), etc.) that wirelessly communicate data, control information, reference signals, etc. (e.g., according to various wireless communication network implementations). The wireless communication network may employ various technologies to improve throughput, achieve a high data rate, and/or improve the energy efficiency of the wireless communication network. These technologies may allow a wireless communication network to support communication between an increasing number of devices and network entities, support advanced functionalities at various devices, and improve the quality of communication between devices and network entities.

Network entities and/or devices in a wireless communications network may experience different types of interference to their communications. As described herein, one of the types of interference that affect the communications may include cross-link interference (CLI). For example, CLI may include first communications for a first device or first network entity experiencing interference from second communications for a second device or second network entity, where the first communications and the second communications may occur at a same time (e.g., on same time-domain resources, such as a same slot). That is, UL communications transmitted by the first device or first network entity may cause CLI on downlink (DL) communications for the second device or second network entity. Additionally or alternatively, DL communications for the first device or first network entity may cause CLI on UL communications for the second device or second network entity

In some aspects, the CLI may arise due to full-duplex communications. For example, a first network entity associated with a first cell (e.g., first coverage area) may employ full-duplex communications for simultaneous transmission of DL communications and reception of UL communications with devices in the first cell on same time-domain resources. In the case of CLI, a second network entity associated with a second cell (e.g., second coverage area) may also employ full-duplex communications for simultaneous transmission of DL communications and reception of UL communications with devices in the second cell on at least a portion of the same time-domain resources as the first network entity, where the first cell and the second cell neighbor each other (e.g., the first network entity and the second network entity at least partially overlap and/or are in close proximity to each other). Accordingly, UL communications sent to the first network entity may cause CLI to DL communications sent by the second network entity, and/or UL communications sent to the second network entity may cause CLI to DL communications sent by the first network entity. In some aspects, the CLI caused by communications between different network entities may be referred to as inter-network entity CLI (e.g., inter-gNB CLI). Additionally or alternatively, the inter-network entity CLI may include DL communications sent by one of the network entities causing CLI on UL communications sent to another network entity. In some aspects, CLI may also include intra-cell inter-UE CLI (e.g., CLI from communication between a first UE and a network entity interfering with a communication between a second UE and the network entity in a same cell) and/or inter-cell inter-UE CLI (e.g., CLI from communication between a first UE and a first network entity interfering with a communication between a second UE and a second network entity, where the UEs are associated with different cells corresponding to the respective network entities).

A UE may measure CLI on a CLI measurement resource. For example, the UE may perform a Layer 1 (L1) CLI measurement on an L1 CLI measurement resource. An L1 CLI measurement may include, for example, a reference signal received power (RSRP) measurement or a received signal strength indicator (RSSI) measurement. An L1 CLI measurement resource may be configured via semi-static signaling (referred to herein as a semi-static configuration type), such as a periodic measurement resource or a semi-persistent measurement resource. Alternatively, an L1 CLI measurement resource may be configured via dynamic signaling, such as an aperiodic measurement resource that is triggered/activated via downlink control information (DCI) signaling.

An L1 CLI measurement resource may be configured (whether semi-statically or dynamically) in a fashion that causes the L1 CLI measurement resource to conflict with another communication. For example, both the L1 CLI measurement resource and the other communication may be configured in an SBFD time resource, such as an SBFD symbol or slot. The other communication may include an uplink communication or a downlink communication, and can be configured in a semi-static fashion or a dynamic fashion. A conflict may occur when the L1 CLI measurement resource at least partially overlaps with the other communication in one or more of time or frequency. For example, a conflict may occur when an SBFD-aware UE (that is, a UE that can interpret SBFD signaling but not perform bidirectional SBFD communication) is configured with an L1 CLI measurement resource that overlaps the other communication in time (and optionally frequency). These conflicts can occur when both the L1 CLI measurement resource and the other communication are configured in the same sub-band or the same communication direction (e.g., uplink versus downlink), or when the L1 CLI measurement resource is configured in a first communication direction and the other communication is configured in a second communication direction different than the first communication direction. Furthermore, conflicts can arise between various combinations of configuration types (e.g., dynamic conflicting with semi-static, semi-static conflicting with semi-static, or dynamic conflicting with dynamic). Without taking into account the different communication directions in which conflicts can occur or the combinations of configuration types associated with the conflicts, resolution of these conflicts may be inconsistently performed, leading to unpredictable network behavior, canceling of important communications or measurement, or the like.

As another example of an L1 CLI measurement resource conflict, an L1 CLI measurement resource can conflict with an SSB. For example, an SSB may occur in an SBFD time resource and may overlap in time with an L1 CLI measurement resource in an uplink sub-band. A UE may prioritize reception of an SSB over an uplink transmission, but an approach for conflict resolution given an L1 CLI measurement resource in an uplink sub-band and an SSB that conflicts with the L1 CLI measurement resource may be undefined. In this scenario, UE capabilities for simultaneous reception of an SSB and performance of an L1 CLI measurement may differ, so an approach that does not take into account these UE capabilities may lead to inconsistencies in network behavior, increase in CLI, and/or failures to synchronize.

Some aspects described herein provide resolution of a conflict between an L1 CLI measurement resource and another communication. This resolution can include performing the communication, performing an L1 CLI measurement on the L1 CLI measurement resource, or identifying an error case. The resolution is based on a first configuration type (e.g., semi-static versus dynamic) of the L1 CLI measurement resource and a second configuration type (e.g., semi-static versus dynamic) of the other communication. In some aspects, the resolution is further based on whether the L1 CLI measurement resource occurs in an uplink sub-band or a downlink sub-band, and/or whether the other communication occurs in the uplink sub-band or the downlink sub-band. By providing approaches for this resolution, predictability of network behavior is improved and prioritization of conflicting measurements and communications is improved.

Some aspects described herein provide resolution of a conflict between an L1 CLI measurement resource and an SSB. This resolution can include receiving the SSB, performing an L1 CLI measurement on the L1 CLI measurement resource, or both. This resolution can alternatively include identifying an error case. The resolution is based on whether the UE supports simultaneous reception of the SSB and performance of the L1 CLI measurement. In some examples, this resolution is further based on whether the UE supports multi-beam reception (for example, when the SSB and the CLI measurement resource have different quasi co-location (QCL) parameters). For example, the UE may receive the SSB and perform the L1 CLI measurement when the SSB and the CLI measurement have the same QCL parameters or the UE is capable of multi-beam reception, and otherwise may only perform one of the measurement or receiving the SSB. By providing approaches for this resolution, predictability of network behavior is improved and prioritization of conflicting measurements and communications is improved. Furthermore, network behavior is more effectively tailored to UE capabilities, thereby improving performance of UEs.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

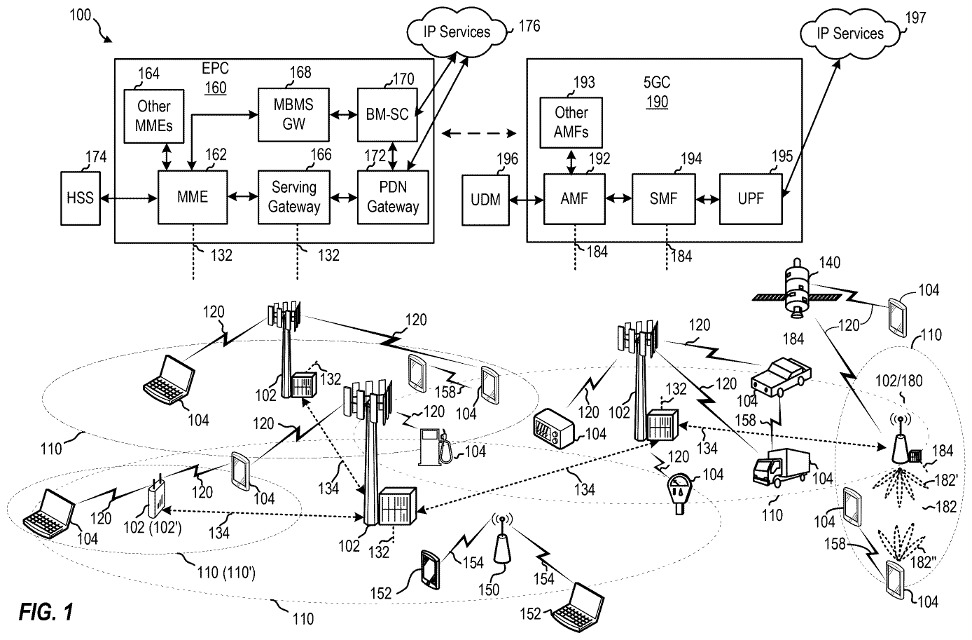

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

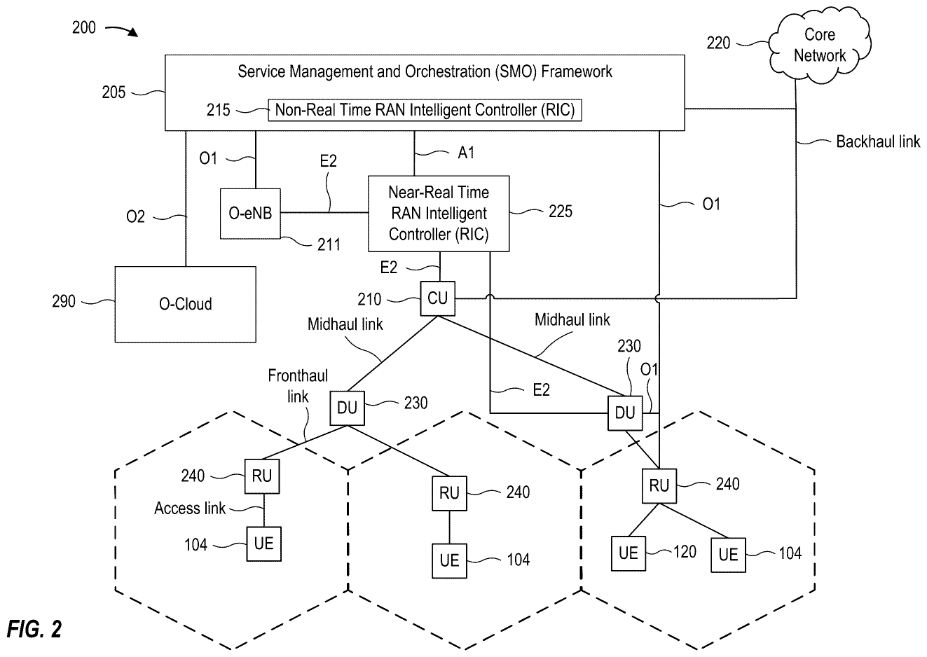

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a sub-band. For example, the Third Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit—User Plane (CU-UP)), control plane functionality (e.g., Central Unit—Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

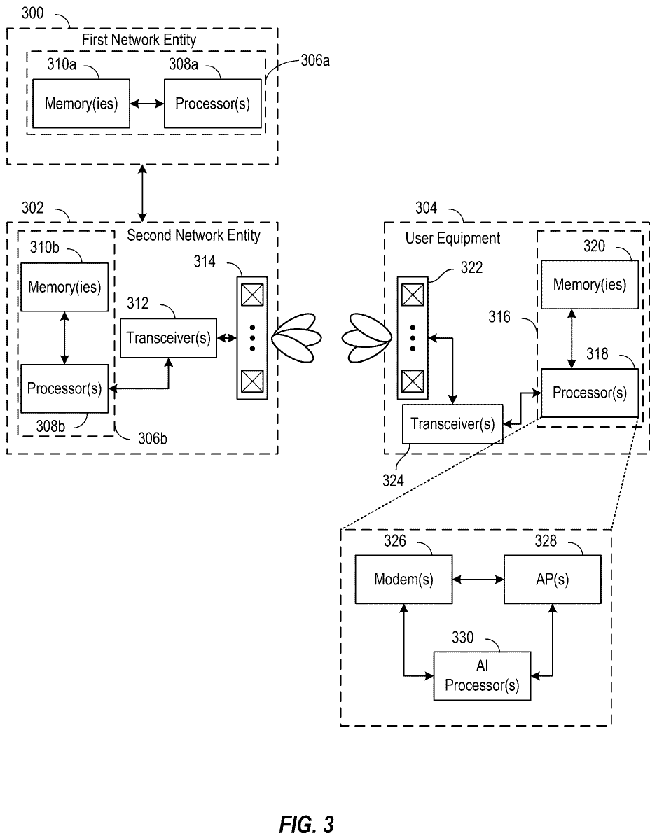

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In s ome examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

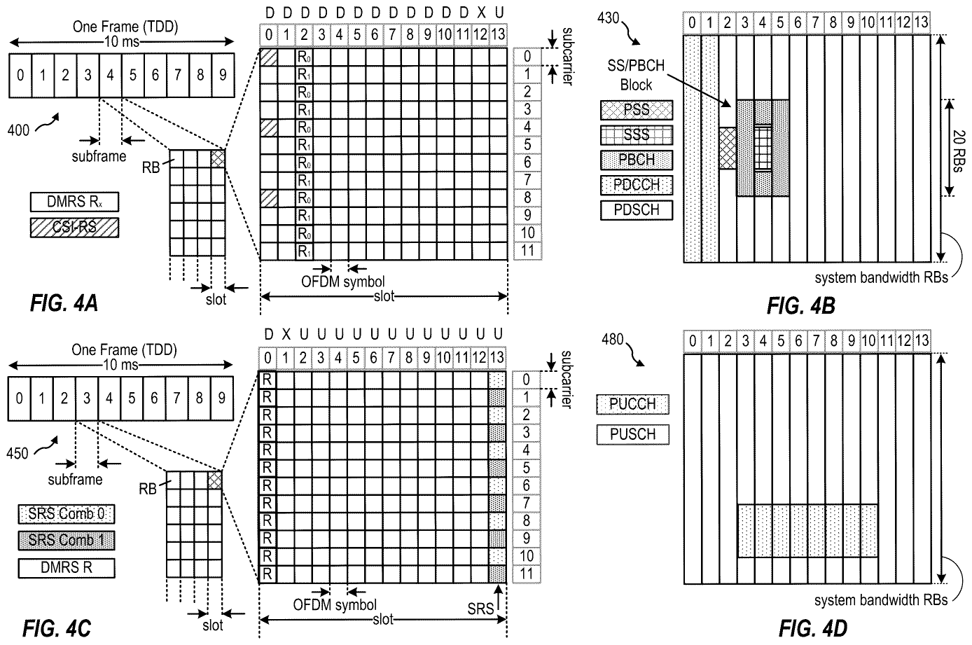

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2^{μ}slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Full-Duplex Communications and CLI

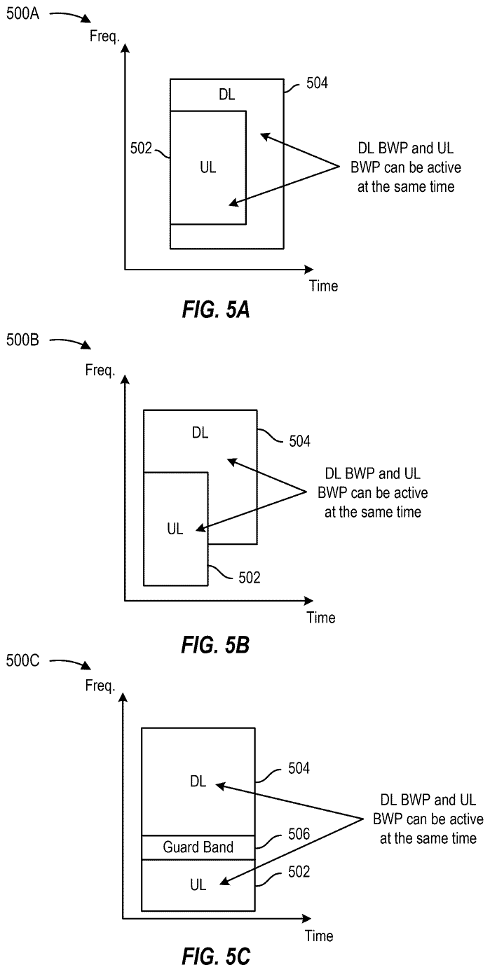

FIGS. 5A, 5B, and 5C depict example configurations for full-duplex communications in accordance with aspects of the present disclosure. For example, FIG. 5A depicts a first configuration 500A for full-duplex communications, FIG. 5B depicts a second configuration 500B for full-duplex communications, and FIG. 5C depicts a third configuration 500C for full-duplex communications. In some aspects, the first configuration 500A, the second configuration 500B, and the third configuration 500C may implement aspects of or may be implemented by aspects of FIGS. 1-4D. For example, a network entity or a UE may use the first configuration 500A, the second configuration 500B, or the third configuration 500C for full-duplex communications. In some aspects, the network entity may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE may be an example of the UE 104 depicted and described with respect to FIG. 1 or the UE 304 depicted and described with respect to FIG. 3. Additionally, the first configuration 500A, the second configuration 500B, and the third configuration 500C may include aspects of the data structures for a wireless communications network depicted and described with respect to FIGS. 4A-4D.

As used herein, full-duplex communications in a wireless network refers to simultaneous bi-directional communication between devices in the wireless network. For example, a UE operating in a full-duplex mode may transmit an UL communication in an UL resource allocation 502 (e.g., an UL bandwidth part (BWP)) and receive a DL communication in a DL resource allocation 504 (e.g., a DL BWP) at the same time (e.g., in the same slot or the same symbol), and/or a network entity operating in a full-duplex mode may receive an UL communication in the UL resource allocation 502 and transmit a DL communication in the DL resource allocation 504 at the same time. Alternatively, half-duplex communications in a wireless network refers to unidirectional communications (e.g., only DL communication or only UL communication) between devices at a given time (e.g., in a given slot or a given symbol).

As shown in FIGS. 5A and 5B, the first configuration 500A and the second configuration 500B show examples of in-band full-duplex (IBFD) communication. In IBFD, the UE may transmit an UL communication to a network entity in the UL resource allocation 502 and receive a DL communication from the network entity in the DL resource allocation 504 on one or more same time and frequency resources, or the network entity may transmit a DL communication to a UE in the DL resource allocation 504 and receive an UL communication from the UE in the UL resource allocation 502 on one or more same time and frequency resources. As shown in the first configuration 500A, in a first example of IBFD, time and frequency resources for the UL resource allocation 502 may fully overlap with time and frequency resources for the DL resource allocation 504. As shown in the second configuration 500B, in a second example of IBFD, time and frequency resources for the UL resource allocation 502 may partially overlap with time and frequency resources for the DL resource allocation 504.

As further shown in FIG. 5C, the third configuration 500C shows an example of sub-band full-duplex (SBFD) communications, which may also be referred to as “sub-band frequency division duplex (SBFDD)” or “flexible duplex.” In SBFD, the UE may transmit an UL communication to a network entity in the UL resource allocation 502 and receive a DL communication from the network entity in the DL resource allocation 504 at the same time, but on different frequency resources. Additionally or alternatively, in SBFD, the network entity may transmit a DL communication to a UE in the DL resource allocation 504 and receive an UL communication from the UE in the UL resource allocation 502 at the same time, but on different frequency resources. For example, the different frequency resources may be sub-bands of a frequency band, such as a TDD band. In this case, the frequency resources used for the DL resource allocation 504 may be separated from the frequency resources used for the UL resource allocation 502, in the frequency domain, by a guard band 506.

SBFD may increase an UL duty cycle, improve UL coverage, and reduce latency, because it is possible to transmit an UL signal in an UL sub-band in DL only or in flexible slots. SBFD may enhance system capacity, resource utilization, and spectrum efficiency. SBFD may enable flexible and dynamic UL and DL resource adaption according to UL and DL traffic in a robust manner. If random access is allowed in SBFD symbols for SBFD-aware UEs (UEs capable of supporting SBFD operation), it may potentially reduce the random access latency, reduce the PRACH collision probability, and/or improve the coverage of PRACH and messages for a RACH procedure. A random access channel (RACH) configuration may indicate a quantity of synchronization signal blocks (SSBs) per RACH occasion (RO) and power information for PRACH messages (e.g., preambles).

As indicated above, FIGS. 5A, 5B, and 5C are provided as examples. Other examples may differ from what is described with respect to FIGS. 5A, 5B, and 5C.

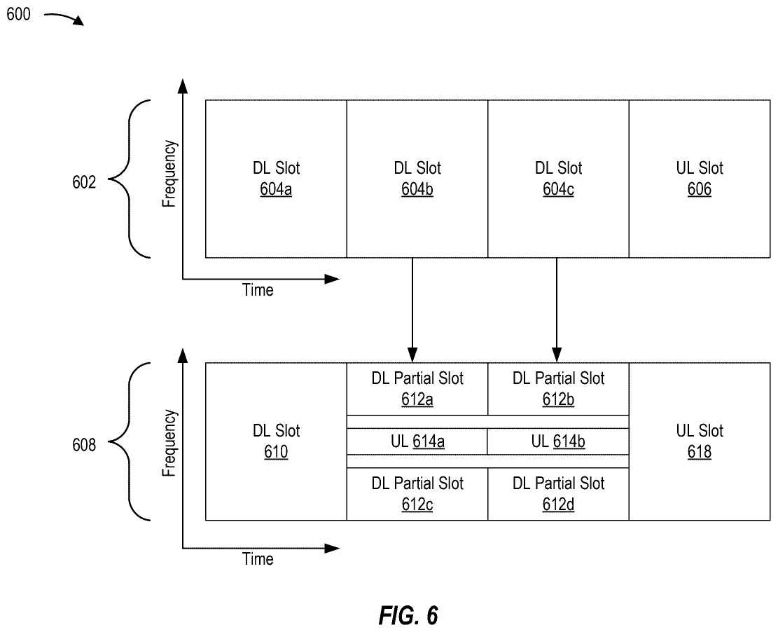

FIG. 6 is a diagram illustrating an example 600 of SBFD activation, in accordance with the present disclosure. As shown in FIG. 6, example 600 includes a first configuration 602. In some aspects, the first configuration 602 may indicate a first slot format pattern (sometimes called a TDD pattern) associated with a half-duplex mode or a full-duplex mode. The first slot format pattern may include a quantity of downlink slots (e.g., three downlink slots 604a, 604b, and 604c, as shown), a quantity of flexible slots (not shown), and/or a quantity of uplink slots (e.g., one uplink slot 606, as shown). The first slot format pattern may repeat over time. In some aspects, a NE 300/302 may indicate the first slot format pattern to a UE 104/304 using one or more slot format indicators. A slot format indicator, for a slot, may indicate whether that slot is an uplink slot, a downlink slot, or a flexible slot, among other examples.

A NE 300/302 may instruct (e.g., using an indication, such as a radio resource control (RRC) message, a medium access control (MAC) control element (CE) (MAC-CE), or downlink control information (DCI)) a UE 104/304 to switch from the first configuration 602 to a second configuration 608. As an alternative, the UE 104/304 may indicate to the NE 300/302 that the UE 104/304 is switching from the first configuration 602 to the second configuration 608. The second configuration 608 may indicate a second slot format pattern that repeats over time, similar to the first slot format pattern. In any of the aspects described above, the UE 104/304 may switch from the first configuration 602 to the second configuration 608 during a time period (e.g., a quantity of symbols and/or an amount of time (e.g., in ms)) based at least in part on an indication received from the NE 300/302 (e.g., before switching back to the first configuration 602). During that time period, the UE 104/304 may communicate using the second slot format pattern, and then may revert to using the first slot format pattern after the end of the time period. The time period may be indicated by the NE 300/302 (e.g., in the instruction to switch from the first configuration 602 to the second configuration 608, as described above) and/or based at least in part on a programmed and/or otherwise preconfigured rule. For example, the rule may be based at least in part on a table (e.g., defined in 3GPP specifications and/or another wireless communication standard) that associates different sub-carrier spacings (SCSs) and/or numerologies (e.g., represented by μ and associated with corresponding SCSs) with corresponding time periods for switching configurations.

In example 600, the second slot format pattern includes two SBFD slots in place of what were downlink slots in the first slot format pattern. In example 600, each SBFD slot includes a partial slot (e.g., a portion or sub-band of a frequency allocated for use by the NE 300/302 and the UE 104/304) for downlink (e.g., partial slots 612a, 612b, 612c, and 612d, as shown) and a partial slot for uplink (e.g., partial slots 614a and 614b, as shown). Accordingly, the UE 104/304 may operate using the second slot format pattern to transmit an uplink communication in an earlier slot (e.g., the second slot in sequence, shown as partial UL slot 614a) as compared to using the first slot format pattern (e.g., the fourth slot in sequence, shown as UL slot 606). Other examples may include additional or alternative changes. For example, the second configuration 608 may indicate an SBFD slot in place of what was an uplink slot in the first configuration 602 (e.g., UL slot 606). In another example, the second configuration 608 may indicate a downlink slot or an uplink slot in place of what was an SBFD slot in the first configuration 602 (not shown in FIG. 6). In yet another example, the second configuration 608 may indicate a downlink slot or an uplink slot in place of what was an uplink slot or a downlink slot, respectively, in the first configuration 602. An “SBFD slot” may refer to a slot in which an SBFD format is used. An SBFD format may include a slot format in which full duplex communication is supported (e.g., for both uplink and downlink communications), with one or more frequencies used for an uplink portion of the slot being separated from one or more frequencies used for a downlink portion of the slot by a guard band. In some aspects, the SBFD format may include a single uplink portion and a single downlink portion separated by a guard band. In some aspects, the SBFD format may include multiple downlink portions and a single uplink portion that is separated from the multiple downlink portions by respective guard bands (e.g., as shown in FIG. 6). In some aspects, an SBFD format may include multiple uplink portions and a single downlink portion that is separated from the multiple uplink portions by respective guard bands. In some aspects, the SBFD format may include multiple uplink portions and multiple downlink portions, where each uplink portion is separated from a downlink portion by a guard band. In some aspects, operating using an SBFD mode may include activating or using an FD mode in one or more slots based at least in part on the one or more slots having the SBFD format. A slot may support the SBFD mode if an UL BWP and a DL BWP are permitted to be or are simultaneously active in the slot in an SBFD fashion (e.g., with guard band separation).

By switching from the first configuration 602 to the second configuration 608, the NE 300/302 and the UE 104/304 may experience increased quality and/or reliability of communications. For example, the NE 300/302 and the UE 104/304 may experience increased throughput (e.g., using a full-duplex mode), reduced latency (e.g., the UE 104/304 may be able to transmit an uplink and/or a downlink communication sooner using the second configuration 608 rather than the first configuration 602), and increased network resource utilization (e.g., by using both the DL BWP and the UL BWP simultaneously instead of only the DL BWP or the UL BWP). The techniques described herein use an indication from the NE 300/302 to the UE 104/304 to instruct the UE 104/304 to operate using an SBFD mode, such as that shown in the second configuration 608.

As indicated above, FIG. 6 is provided as an example. Other examples may differ from what is described with respect to FIG. 6.

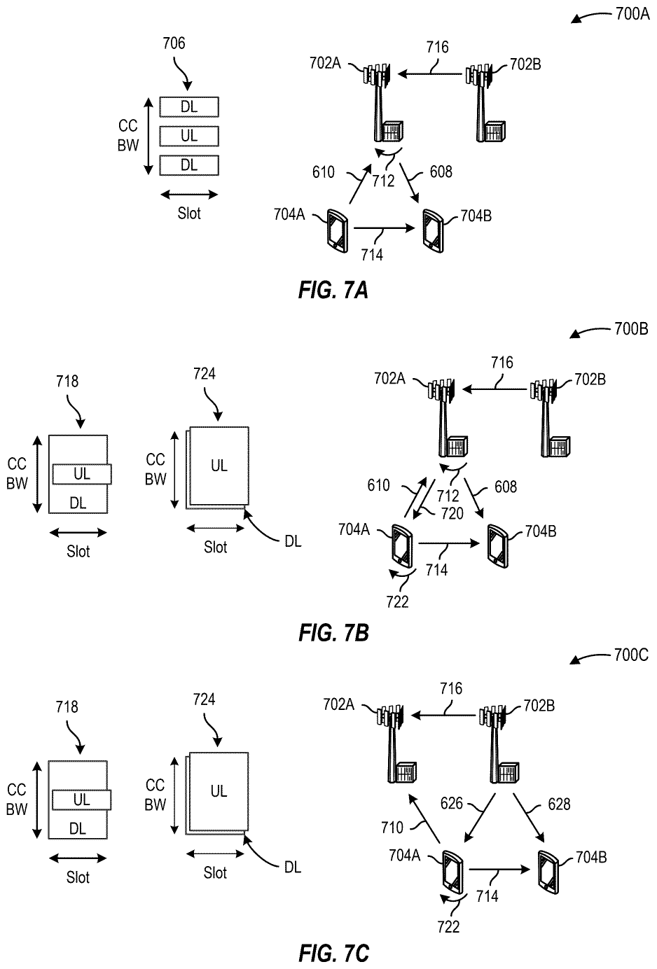

FIGS. 7A, 7B, and 7C depict examples of interference scenarios based on full-duplex communications. For example, FIG. 7A depicts a first interference scenario 700A based on full-duplex communications, FIG. 7B depicts a second interference scenario 700B based on full-duplex communications, and FIG. 7C depicts a third interference scenario 700C based on full-duplex communications.

In some aspects, the first interference scenario 700A, the second interference scenario 700B, and the third interference scenario 700C may implement aspects of or may be implemented by aspects of FIGS. 1-6. For example, the first interference scenario 700A, the second interference scenario 700B, and the third interference scenario 700C may include a first network entity 702A, a second network entity 702B, a first UE 704A, and a second UE 704B. In some aspects, the first network entity 702A and the second network entity 702B may be examples of the BS 102 depicted and described with respect to FIG. 1, the first network entity 300 or the second network entity 302 depicted and described with respect to FIG. 3, a disaggregated base station depicted and described with respect to FIG. 2, or the network entity described with respect to FIGS. 5A-5C. Similarly, the first UE 704A and the second UE 704B may be examples of the UE 104 depicted and described with respect to FIG. 1, the UE 304 depicted and described with respect to FIG. 3, or the UE described with respect to FIGS. 5A-5C. Additionally, the first interference scenario 700A, the second interference scenario 700B, and the third interference scenario 700C may include aspects of the data structures for a wireless communications network depicted and described with respect to FIGS. 4A-4D. FIGS. 7A, 7B, and 7C are provided as examples. Other examples of interference scenarios may differ from what is described with respect to FIGS. 7A, 7B, and 7C.

In the first interference scenario 700A depicted in the example of FIG. 7A, the first network entity 702A (e.g., a full-duplex gNB) may use a SBFD communication 706 (e.g., the SBFD communications depicted and described with respect to FIG. 5C) to concurrently communicate with the first UE 704A (e.g., a half-duplex UE) and the second UE 704B (e.g., a half-duplex UE). For example, the first network entity 702A may send a DL transmission 708 to the second UE 704B at the same time that the first UE 704A sends an UL transmission 710 to the first network entity 702A. In the first scenario 700A, the DL transmission 708 may result in a network entity self-interference 712 at the first network entity 702A when the first network entity 702A is attempting to decode the UL transmission 710. In some aspects, the UL transmission 710 may result in a inter-UE CLI 714 (e.g., an intra-cell UE-to-UE CLI) at the second UE 704B when the second UE 704B is attempting to decode the DL transmission 708.

Additionally, in the first scenario 700A depicted in the example of FIG. 7A, the second network entity 702B (e.g., a full-duplex gNB) may transmit a DL transmission to an additional UE (not shown) at the same time that the first UE 704A transmits the UL transmission 710 to the first network entity 702A. Accordingly, the DL transmission by the second network entity 702B may result in an inter-network entity CLI 716 (e.g., inter-gNB CLI) at the first network entity 702A when the first network entity 702A is attempting to decode the UL transmission 710.

In the second interference scenario 700B depicted in the example of FIG. 7B, the first network entity 702A (e.g., a full-duplex gNB) may concurrently use a full-duplex communication 718 (e.g., the partially-overlapping IBFD communications depicted and described with respect to FIG. 5A) or a full-duplex configuration 724 (e.g., the full-overlapping IBFD communications depicted and described with respect to FIG. 5B) to communicate with the first UE 704A (e.g., a full-duplex UE) and half-duplex communication to communicate with the second UE 704B (e.g., a half-duplex UE). For example, the first network entity 702A may transmit the DL transmission 708 to the second UE 704B at the same time that the first UE 704A transmits the UL transmission 710 to the first network entity 702A. At the same time, the first network entity 702A may transmit a DL transmission 720 to the first UE 704A. Accordingly, the DL transmission 708 or the DL transmission 720 may result in the network entity self-interference 712 at the first network entity 702A when the first network entity 702A is attempting to decode the UL transmission 710. In some aspects, the UL transmission 710 may result in a UE self-interference 722 at the first UE 704A when the first UE 704A is attempting to decode the DL transmission 720. Additionally, the UL transmission 710 may result in the inter-UE CLI 714 at the second UE 704B when the second UE 704B is attempting to decode the DL transmission 708. In some aspects, a DL transmission by the second network entity 702B may also result in the inter-network entity CLI 716 at the first network entity 702A when the first network entity 702A is attempting to decode the UL transmission 710.

In the third interference scenario 700C depicted in the example of FIG. 7C, the second network entity 702B may communicate with the first UE 704A (e.g., a full-duplex UE) and the second UE 704B (e.g., a half-duplex UE), where the first UE 704A uses the full-duplex communication 718 or the full-duplex configuration 724. As shown, the second network entity 702B may transmit a DL transmission 726 to the first UE 704A at the same time as transmitting a DL transmission 728 to the second UE 704B. At the same time, the first UE 704A may transmit the UL transmission 710 to the first network entity 702A. Accordingly, the UL transmission 710 may result in the UE self-interference 722 at the first UE 704A when the first UE 704A is attempting to decode the DL transmission 726. Additionally, the UL transmission 710 may result in the inter-UE CLI 714 at the second UE 704B when the second UE 704B is attempting to decode the DL transmission 728. In some aspects, the DL transmission 726 or the DL transmission 728 may result in the inter-network entity CLI 716 at the first network entity 702A when the first network entity 702A is attempting to decode the UL transmission 710. In some aspects, the first network entity 702A and the second network entity 702B may be different transmission and reception points (TRPs) of a same network entity, where the same network entity is a multi-TRP entity.

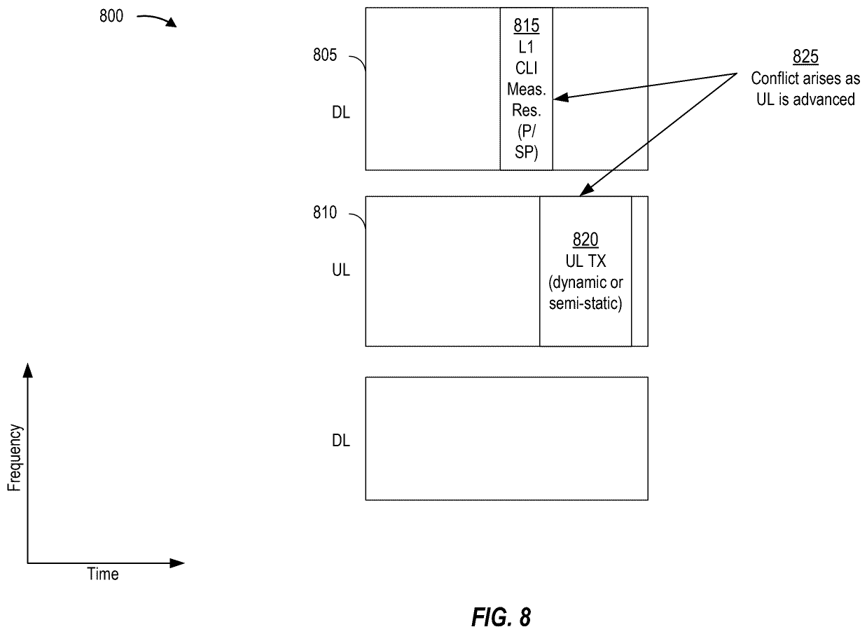

FIG. 8 is a diagram illustrating an example 800 of a conflict on an SBFD time resource. Example 800 involves a downlink sub-band 805 and an uplink sub-band 810. An L1 CLI measurement resource 815 is configured in the downlink sub-band 805. For example, a network entity may transmit, and a UE may receive, a configuration of the L1 CLI measurement resource 815 in the SBFD time resource. In example 800, the L1 CLI measurement resource 815 is configured via higher-layer signaling, such as RRC signaling. For example, the L1 CLI measurement resource 815 may be a periodic CLI resource or a semi-persistent CLI resource. Thus, the L1 CLI measurement resource 815 has a first configuration type that is a semi-static configuration type (since the L1 CLI measurement resource 815 is periodic or semi-persistent). The L1 CLI measurement resource 815 may be associated with received signal strength indication (RSSI) measurement or another form of CLI measurement within a downlink sub-band 805. Example 800 also includes an uplink communication 820 in the uplink sub-band 810. As shown at 825, the uplink communication 820 conflicts with the L1 CLI measurement resource 815.

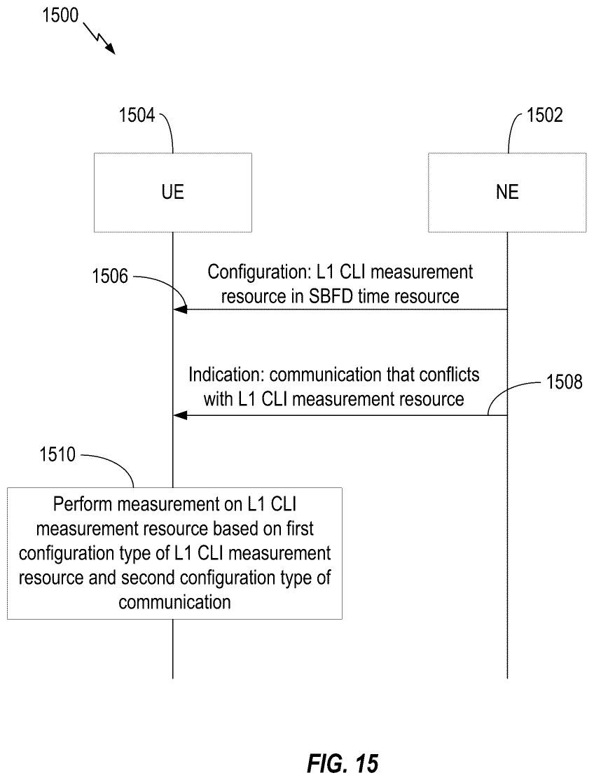

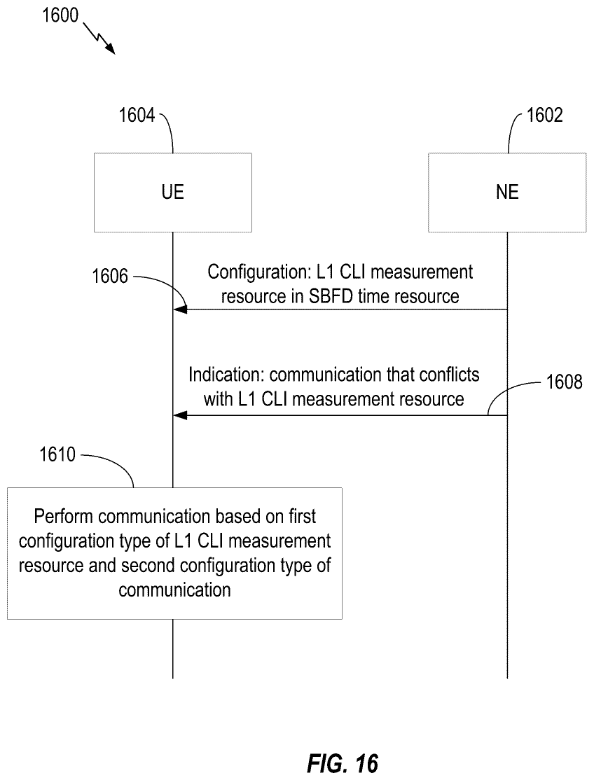

In some aspects, the uplink communication 820 has a second configuration type that is a dynamic configuration type. For example, the uplink communication 820 may include a dynamic grant (DG) physical uplink shared channel (PUSCH), an aperiodic SRS, a physical uplink control channel (PUCCH) (e.g., triggered by physical downlink control channel (PDCCH) order), or a physical random access channel (PRACH) communication triggered by PDCCH order. Thus, the first configuration type is a semi-static configuration type, the L1 CLI measurement resource is in a downlink sub-band 805, and the second configuration type is a dynamic configuration type. In such examples, in some aspects, the UE may perform the uplink communication 820. For example, the UE may perform the uplink communication 820 as described with respect to 1610 of FIG. 16. Thus, the UE may prioritize the uplink communication 820 and drop the L1 CLI measurement resource 815. Alternatively, in some aspects, the UE may perform the measurement of the L1 CLI measurement resource 815 subject to a scheduling restriction on the uplink. For example, the scheduling restriction may apply to the L1 CLI measurement resource 815 and a number of symbols prior to the uplink communication 820 (e.g., 1 symbol or 2 symbols). Thus, the UE may not transmit the uplink communication 820 in symbols subject to the scheduling restriction. For example, the UE may perform the measurement as described with respect to 1510 of FIG. 15.

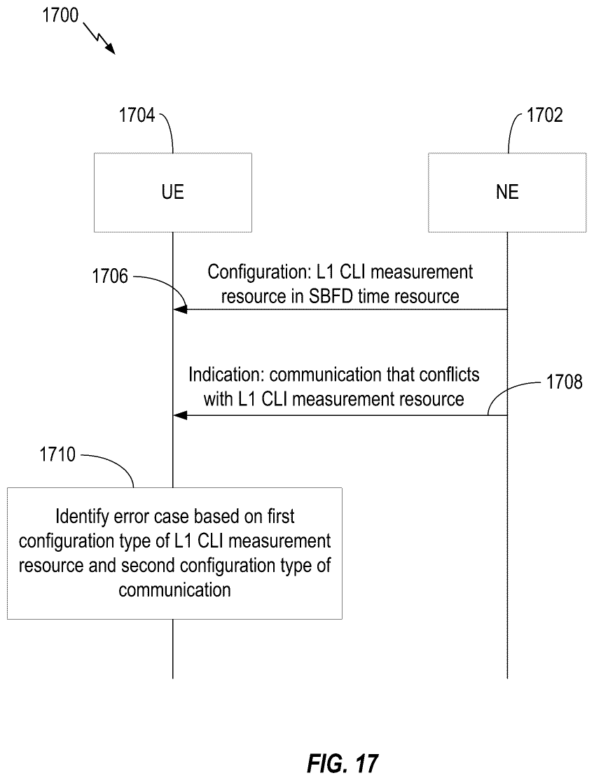

In some aspects, the uplink communication 820 has a second configuration type that is a semi-static configuration type. For example, the uplink communication 820 may be configured via configured grant PUSCH (CG-PUSCH), may be a periodic SRS, may be a semi-persistent SRS, or the like. Thus, the first configuration type is a first semi-static configuration type, the L1 CLI measurement resource 815 is in a downlink sub-band, 805, and the second configuration type is a second semi-static configuration type. In such examples, in some aspects, the UE may identify an error case. For example, the UE may identify the error case as described with respect to 1710 of FIG. 17. Alternatively, in some aspects, the UE may perform the measurement of the L1 CLI measurement resource 815 subject to a scheduling restriction on the uplink. For example, the scheduling restriction may apply to the L1 CLI measurement resource 815 and a number of symbols prior to the uplink communication 820 (e.g., 1 symbol or 2 symbols). Thus, the UE may not transmit the uplink communication 820 in symbols subject to the scheduling restriction. For example, the UE may perform the measurement as described with respect to 1510 of FIG. 15.

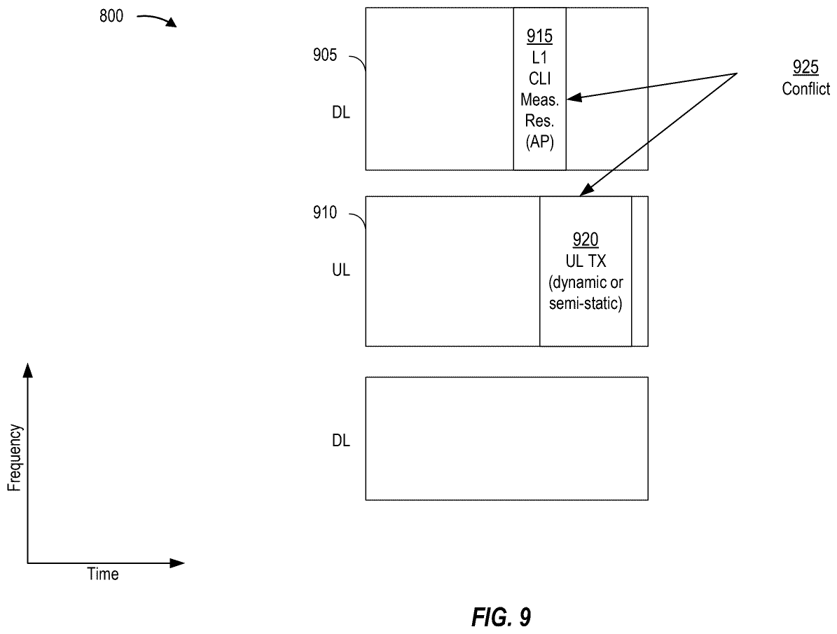

FIG. 9 is a diagram illustrating an example 900 of a conflict on an SBFD time resource. Example 900 involves a downlink sub-band 905 and an uplink sub-band 910. An L1 CLI measurement resource 915 is configured or scheduled in the downlink sub-band 905. For example, a network entity may transmit, and a UE may receive, a configuration of the L1 CLI measurement resource 915 in the SBFD time resource. In example 900, the L1 CLI measurement resource 915 is triggered by DCI. For example, the L1 CLI measurement resource 915 may be an aperiodic CLI resource. Thus, the L1 CLI measurement resource 915 has a first configuration type that is a dynamic configuration type (since the L1 CLI measurement resource 915 is aperiodic). The L1 CLI measurement resource 915 may be associated with RSSI or other CLI measurement within a downlink sub-band 905. Example 900 also includes an uplink communication 920 in the uplink sub-band 910. As shown at 925, the uplink communication 920 conflicts with the L1 CLI measurement resource 915.

In some aspects, the uplink communication 920 has a second configuration type that is a dynamic configuration type. For example, the uplink communication 920 may include a DG-PUSCH, an aperiodic SRS, a PUCCH (e.g., triggered by PDCCH order), or a PRACH communication triggered by PDCCH order. Thus, the first configuration type is a first dynamic configuration type, the L1 CLI measurement resource 915 is in a downlink sub-band 905, and the second configuration type is a second dynamic configuration type. In such examples, in some aspects, the UE may identify an error case. For example, the UE may identify the error case when both the L1 CLI measurement resource 915 and the uplink communication 920 are dynamically scheduled, as described with respect to 1710 of FIG. 17.

In some aspects, the uplink communication 920 has a second configuration type that is a semi-static configuration type. For example, the uplink communication 920 may be configured via CG-PUSCH, may be a periodic SRS, may be a semi-persistent SRS, or the like. For example, the first configuration type is a dynamic configuration type, the L1 CLI measurement resource 915 is in a downlink sub-band 905, and the second configuration type is a semi-static configuration type. In such examples, in some aspects, the UE may perform one of the measurement on the L1 CLI measurement resource 915 or the uplink communication 920 in accordance with a cancellation timeline for the communication. For example, if dynamic signaling that schedules the L1 CLI measurement resource 915 is received at least a length of time (defined by the cancellation timeline) before the uplink communication 920 is scheduled, then the UE may perform the measurement. Otherwise, the UE may perform the uplink communication 920.

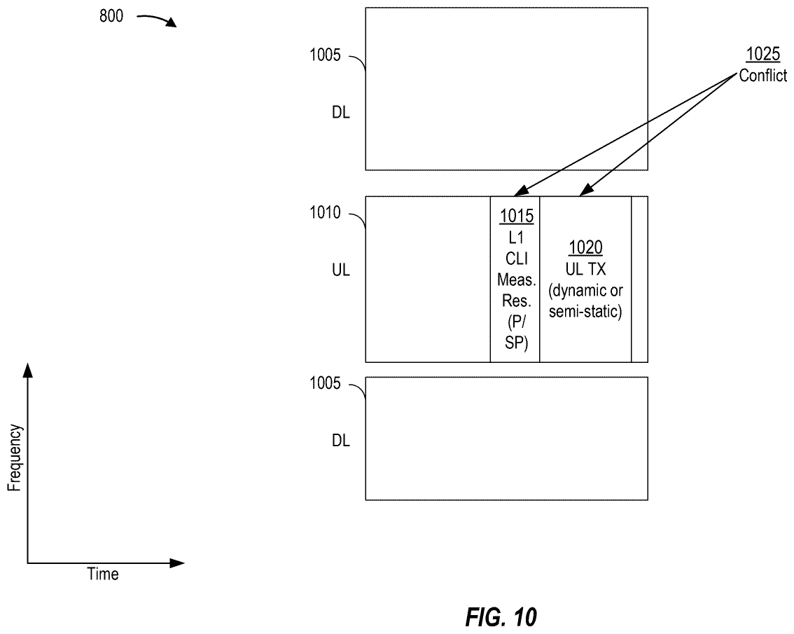

FIG. 10 is a diagram illustrating an example 1000 of a conflict on an SBFD time resource. Example 1000 involves a downlink sub-band 1005 and an uplink sub-band 1010, though in example 1000, an L1 CLI measurement resource 1015 is configured or scheduled in the uplink sub-band 1010, and a communication 1020 is configured or scheduled in the uplink sub-band 1010. For example, a network entity may transmit, and a UE may receive, a configuration of the L1 CLI measurement resource 1015 in the SBFD time resource. In example 1000, the L1 CLI measurement resource 1015 is configured via higher-layer signaling, such as RRC signaling. For example, the L1 CLI measurement resource 1015 may be a periodic or semi-persistent CLI resource. Thus, the L1 CLI measurement resource 1015 has a first configuration type that is a semi-static configuration type. The L1 CLI measurement resource 1015 may be associated with RSSI measurement or another form of measurement (e.g., sounding reference signal reference signal received power (SRS-RSRP) measurement within the uplink sub-band 1010. Example 1000 also includes an uplink communication 1020 in the uplink sub-band 1010. As shown at 1025, the uplink communication 1020 conflicts with the L1 CLI measurement resource 1015.

In some aspects, the uplink communication 1020 has a second configuration type that is a dynamic configuration type. For example, the uplink communication 1020 may include a DG-PUSCH, an aperiodic SRS, a PUCCH (e.g., triggered by PDCCH order), or a PRACH communication triggered by PDCCH order. Thus, the first configuration type is a semi-static configuration type, the L1 CLI measurement resource is in an uplink sub-band 1010, and the second configuration type is a dynamic configuration type. In such examples, in some aspects, the UE may perform the uplink communication 1020. For example, the UE may perform the uplink communication 1020 as described with respect to 1610 of FIG. 16. Thus, the UE may prioritize the uplink and drop L1 CLI measurement resources 1015. Alternatively, in some aspects, the UE may perform the measurement of the L1 CLI measurement resource 1015 subject to a scheduling restriction on the uplink. For example, the scheduling restriction may apply to the L1 CLI measurement resource 1015 and a number of symbols prior to the L1 CLI measurement resource 1015 or the uplink communication 1020 (e.g., 1 symbol or 2 symbols). Thus, the UE may not transmit the uplink communication 1020 in symbols subject to the scheduling restriction (e.g., symbols that overlap the L1 CLI measurement resource 1015, referred to as an overlapped portion). For example, the UE may perform the measurement as described with respect to 1510 of FIG. 15.

In some aspects, the uplink communication 1020 has a second configuration type that is a semi-static configuration type. For example, the uplink communication 1020 may be configured via CG-PUSCH, may be a periodic SRS, may be a semi-persistent SRS, or the like. Thus, the first configuration type is a first semi-static configuration type, the L1 CLI measurement resource 1015 is in an uplink sub-band 1010, and the second configuration type is a second semi-static configuration type. In such examples, in some aspects, the UE may perform one of the measurement on the L1 CLI measurement resource 1015 or the uplink communication 1020 in accordance with a cancellation timeline for the communication. For example, if signaling that schedules the L1 CLI measurement resource 1015 is received at least a length of time (defined by the cancellation timeline) before the uplink communication 1020 is scheduled, then the UE may perform the measurement. Otherwise, the UE may perform the uplink communication 1020. Alternatively, in some aspects, the UE may perform the measurement of the L1 CLI measurement resource 1015 subject to a scheduling restriction on the uplink. For example, the scheduling restriction may apply to the L1 CLI measurement resource 1015 and a number of symbols prior to the L1 CLI measurement resource 1015 or the uplink communication 1020 (e.g., 1 symbol or 2 symbols). Thus, the UE may not transmit the uplink communication 1020 in symbols subject to the scheduling restriction (e.g., symbols that overlap the L1 CLI measurement resource 1015). For example, the UE may perform the measurement as described with respect to 1510 of FIG. 15.

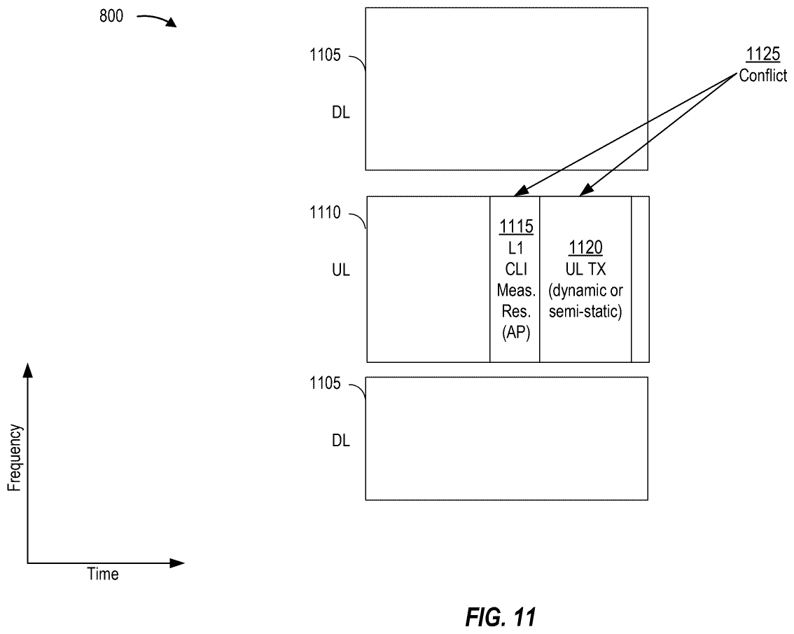

FIG. 11 is a diagram illustrating an example 1100 of a conflict on an SBFD time resource. Example 1100 involves a downlink sub-band 1105 and an uplink sub-band 1110, though in example 1100, an L1 CLI measurement resource 1115 is configured or scheduled in the uplink sub-band 1110, and a communication 1120 is configured or scheduled in the uplink sub-band 1110. For example, a network entity may transmit, and a UE may receive, a configuration of the L1 CLI measurement resource 1115 in the SBFD time resource. In example 1100, the L1 CLI measurement resource 1115 is triggered via DCI. For example, the L1 CLI measurement resource 1115 may be an aperiodic CLI resource. Thus, the L1 CLI measurement resource 1115 has a first configuration type that is a dynamic configuration type (e.g., based on the L1 CLI measurement resource 1115 being aperiodic). The L1 CLI measurement resource 1115 may be associated with RSSI measurement or other measurement (e.g., RSRP measurement) within an uplink sub-band 1110. Example 1100 also includes an uplink communication 1120 in the uplink sub-band 1110. As shown at 1125, the uplink communication 1120 conflicts with the L1 CLI measurement resource 1115.

In some aspects, the uplink communication 1120 has a second configuration type that is a dynamic configuration type. For example, the uplink communication 1120 may include a DG-PUSCH, an aperiodic SRS, a PUCCH (e.g., triggered by PDCCH order), or a PRACH communication triggered by PDCCH order. Thus, the L1 CLI measurement resource 1115 has a dynamic configuration type and occurs in an uplink sub-band 1110 and the uplink transmission 1120 has a dynamic configuration type and occurs in the uplink sub-band 1110. In such examples, in some aspects, the UE may identify an error case as described in connection with 1710 of FIG. 17.

In some aspects, the uplink communication 1120 has a second configuration type that is a semi-static configuration type. For example, the uplink communication 1120 may be configured via CG-PUSCH, may be a periodic SRS, may be a semi-persistent SRS, or the like. Thus, the first configuration type is a dynamic configuration type, the communication is an uplink communication, the L1 CLI measurement resource is in an uplink sub-band, and the second configuration type is a semi-static configuration type. In such examples, in some aspects, the UE may perform one of the measurement on the L1 CLI measurement resource 1115 or the uplink communication 1120 in accordance with a cancellation timeline for the communication. For example, if dynamic signaling that schedules or triggers the L1 CLI measurement resource 1115 is received at least a length of time (defined by the cancellation timeline) before the uplink communication 1120 is scheduled, then the UE may perform the measurement. Otherwise, the UE may perform the uplink communication 1120.

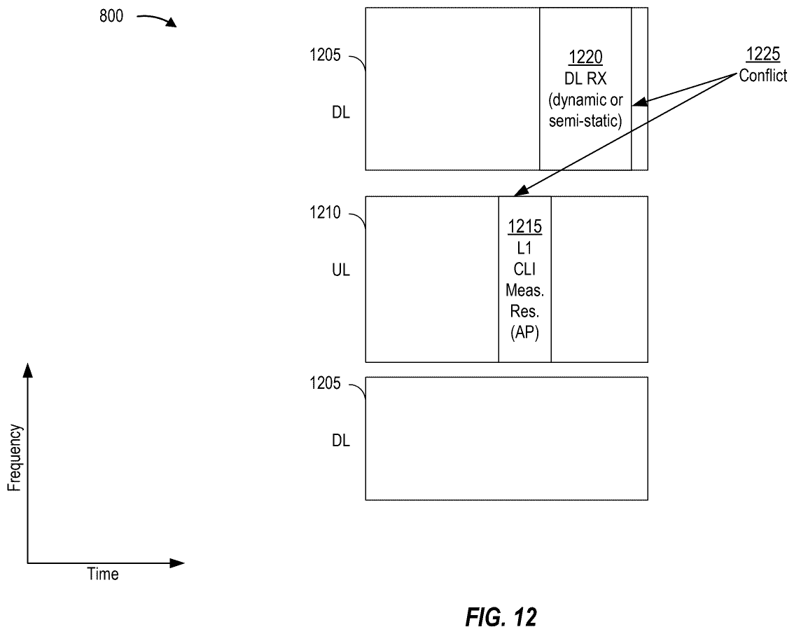

FIG. 12 is a diagram illustrating an example 1200 of a conflict on an SBFD time resource. Example 1200 involves a downlink sub-band 1205 and an uplink sub-band 1210. An L1 CLI measurement resource 1215 is configured or scheduled in the uplink sub-band 1210, and a communication 1220 is configured or scheduled in the downlink sub-band 1205. For example, a network entity may transmit, and a UE may receive, a configuration of the L1 CLI measurement resource 1215 in the SBFD time resource. In example 1200, the L1 CLI measurement resource 1215 is triggered via DCI. For example, the L1 CLI measurement resource 1215 may be an aperiodic CLI resource. Thus, the L1 CLI measurement resource 1215 has a first configuration type that is a dynamic configuration type (since the L1 CLI measurement resource 1215 is an aperiodic resource). The L1 CLI measurement resource 1215 may be associated with RSSI measurement or other CLI measurement (e.g., SRS-RSRP) within an uplink sub-band 1210. Example 1200 also includes a downlink communication 1220 in the downlink sub-band 1205. As shown at 1225, the downlink communication 1220 conflicts with the L1 CLI measurement resource 1215. In example 1200, the UE supports performing only one of the measurement on the L1 CLI measurement resource 1215, or the downlink communication 1220, at a given time. For example, the UE may not support simultaneous CLI measurement and downlink reception.

In some aspects, the downlink communication 1220 has a second configuration type that is a dynamic configuration type. For example, the downlink communication 1220 may include a DG-PDSCH, an aperiodic CSI-RS, or the like. Thus, the first configuration type is a first dynamic configuration type and the second configuration type is a second dynamic configuration type. In some aspects, the UE may identify an error case (e.g., based on the first and second configuration types being dynamic configuration types), as described at 1710 of FIG. 17.

In some aspects, the downlink communication 1220 has a second configuration type that is a semi-static configuration type. For example, the downlink communication 1220 may include a semi-persistent scheduling (SPS) PDSCH, a periodic CSI-RS, a semi-persistent CSI-RS, or the like. Thus, the first configuration type is a dynamic configuration type and the second configuration type is a semi-static configuration type. In such examples, in some aspects, the UE may perform the measurement on the L1 CLI measurement resource 1215, as described with respect to 1510 of FIG. 15. Thus, the UE is not expected to receive on the downlink for a semi-statically configured downlink communication 1220 and a semi-statically configured aperiodic L1 CLI measurement resource 1215 that conflict with one another.

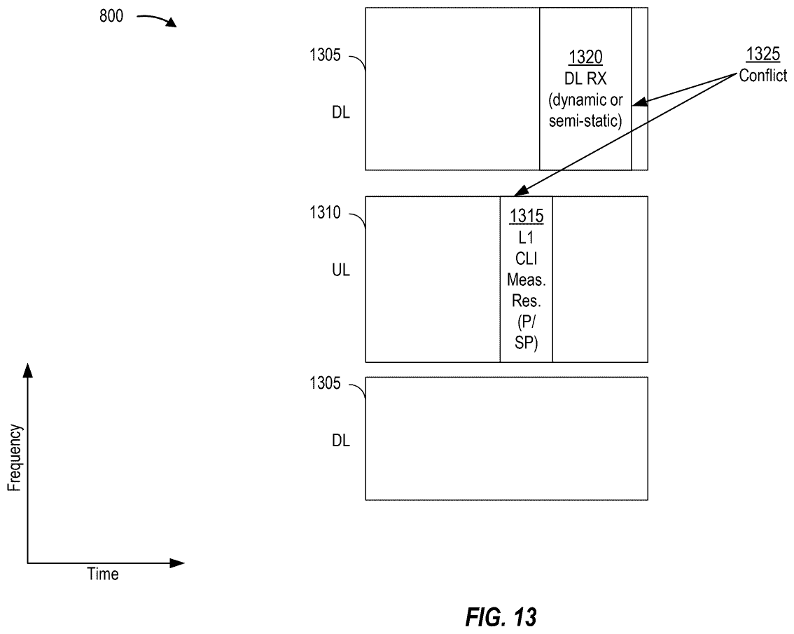

FIG. 13 is a diagram illustrating an example 1300 of a conflict on an SBFD time resource. Example 1300 involves a downlink sub-band 1305 and an uplink sub-band 1310. An L1 CLI measurement resource 1315 is configured or scheduled in the uplink sub-band 1310, and a communication 1320 is configured or scheduled in the downlink sub-band 1305. For example, a network entity may transmit, and a UE may receive, a configuration of the L1 CLI measurement resource 1315 in the SBFD time resource. In example 1300, the L1 CLI measurement resource 1315 is configured via higher layer signaling. For example, the L1 CLI measurement resource 1315 may be a periodic or semi-persistent CLI resource. Thus, the L1 CLI measurement resource 1315 has a first configuration type that is a semi-static configuration type (since the L1 CLI measurement resource 1315 is periodic or semi-persistent). The L1 CLI measurement resource 1315 may be associated with RSSI measurement or other CLI measurement within an uplink sub-band 1310. Example 1300 also includes a downlink communication 1320 in the downlink sub-band 1305. As shown at 1325, the downlink communication 1320 conflicts with the L1 CLI measurement resource 1315. In example 1300, the UE supports performing only one of the measurement on the L1 CLI measurement resource 1315, or the downlink communication 1320, at a given time. For example, the UE may not support simultaneous CLI measurement and downlink reception.

In some aspects, the downlink communication 1320 has a second configuration type that is a dynamic configuration type. For example, the downlink communication 1320 may include a DG-PDSCH, an aperiodic CSI-RS, or the like. Thus, the first configuration type is a semi-static configuration type and the second configuration type is a dynamic configuration type. In such examples, in some aspects, the UE may perform the measurement as described with respect to 1510 of FIG. 15. For example, the UE may not be expected to receive the downlink communication 1320. Alternatively, the UE may perform the downlink communication 1320, as described with respect to 1610 of FIG. 16. For example, the UE may prioritize downlink reception.

In some aspects, the downlink communication 1320 has a second configuration type that is a semi-static configuration type. For example, the downlink communication 1320 may include an SPS-PDSCH, a periodic CSI-RS, a semi-persistent CSI-RS, or the like. Thus, the first configuration type is a first semi-static configuration type and the second configuration type is a second semi-static configuration type. In such examples, in some aspects, the UE may perform the measurement as described with respect to 1510 of FIG. 15. For example, the UE may not be expected to receive the downlink communication 1320. Alternatively, the UE may identify an error case as described with respect to 1710 of FIG. 17. Alternatively, the UE may perform the downlink communication 1320 as described with respect to 1610 of FIG. 16.

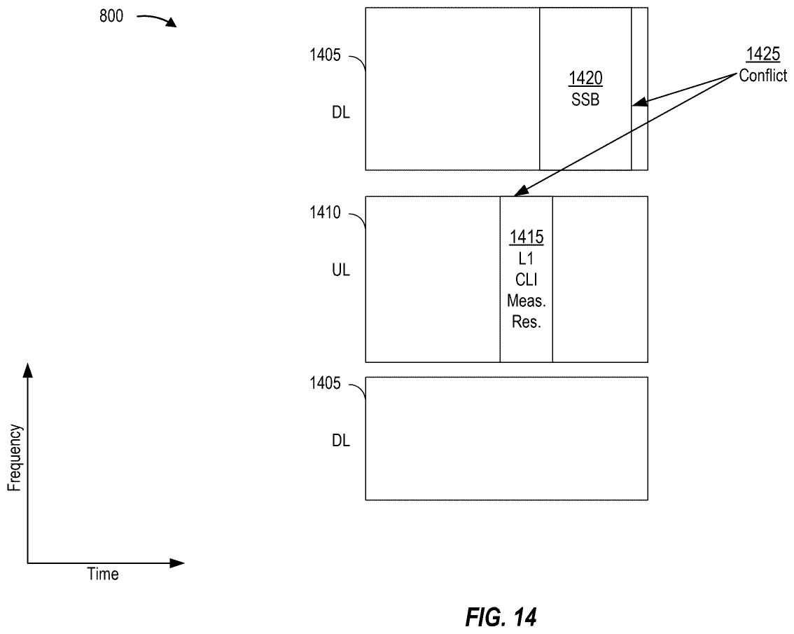

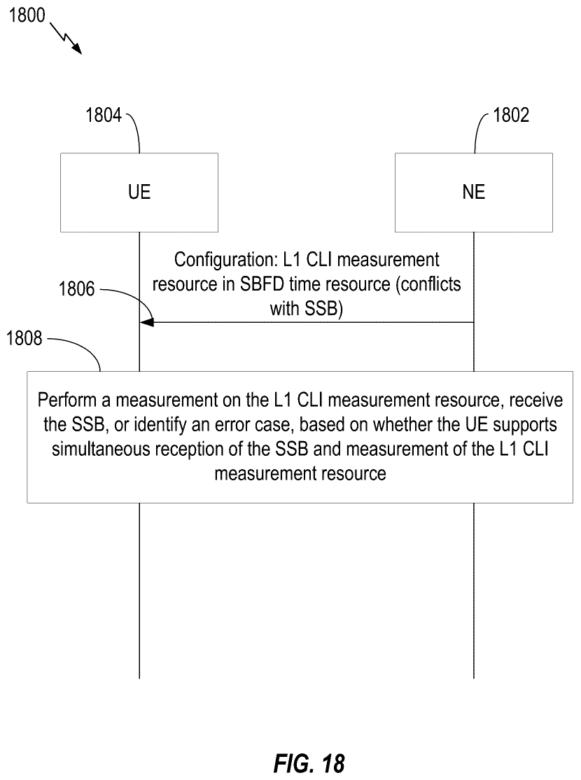

FIG. 14 is a diagram illustrating an example 1400 of a conflict on an SBFD time resource. Example 1400 involves a downlink sub-band 1405 and an uplink sub-band 1410. An L1 CLI measurement resource 1415 is configured or scheduled in the uplink sub-band 1410, and an SSB 1420 is configured or scheduled in the downlink sub-band 1405. For example, a network entity may transmit, and a UE may receive, a configuration of the L1 CLI measurement resource 1415 in the SBFD time resource. As shown by 1425, the L1 CLI measurement resource 1415 conflicts with the SSB 1420. For example, the L1 CLI measurement resource 1415 may at least partially overlap with the SSB 1420 in time. The UE may perform an action based on whether the UE supports simultaneous reception of the SSB 1420 and measurement of the L1 CLI measurement resource 1415. Examples of such an action and situations where the UE may perform each action are described with respect to FIG. 18.

FIG. 15 depicts a process flow 1500 for communications in a network between a network entity 1502 and a UE 1504. In some aspects, the network entity 1502 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 1504 may be an example of UE 104 depicted and described with respect to FIG. 1 or the UE 304 depicted and described with respect to FIG. 3. However, in other aspects, UE 1504 may be another type of wireless communications device and network entity 1502 may be another type of network entity or network node, such as those described herein. Note that any operations or signaling illustrated with dashed lines may indicate that that operation or signaling is an optional or alternative example.

At 1506, the network entity 1502 transmits, and the UE 1504 receives, a configuration of an L1 CLI measurement resource in an SBFD time resource. This configuration may use higher-layer signaling (e.g., for a semi-static configuration type of L1 CLI measurement resource) or dynamic signaling (e.g., for a dynamic configuration type of L1 CLI measurement resource). Examples of the L1 CLI measurement resource include L1 CLI measurement resource 815, L1 CLI measurement resource 915, L1 CLI measurement resource 1015, L1 CLI measurement resource 1115, L1 CLI measurement resource 1215, and L1 CLI measurement resource 1315. The L1 CLI measurement resource may have a semi-static configuration type (e.g., for a periodic L1 CLI measurement resource which is configured to occur according to a defined periodicity, or for a semi-persistent L1 CLI measurement resource which is configured semi-statically and then subsequently activated or deactivated via dynamic signaling) or a dynamic configuration type (e.g., for an aperiodic L1 CLI measurement resource which may be triggered by dynamic signaling).

At 1508, the network entity 1502 transmits, and the UE 1504 receives, an indication of a communication that conflicts with the L1 CLI measurement resource. The communication can be an uplink communication (e.g., in an uplink sub-band) or a downlink communication (e.g., in a downlink sub-band). In some aspects, the communication conflicts with the L1 CLI measurement resource because the communication overlaps with the L1 CLI measurement resource in the time domain. In some aspects, the communication conflicts with the L1 CLI measurement resource because the communication overlaps with the L1 CLI measurement resource in both the time domain and the frequency domain. In some aspects, the communication is in a same sub-band as the L1 CLI measurement resource. In some aspects, the communication is in a first sub-band and the L1 CLI measurement resource is in a second sub-band different than the first sub-band. Examples of the communication include communications 820, 920, 1020, 1120, 1220, and 1320.

At 1510, the UE 1504 performs a measurement on the L1 CLI resource. For example, the UE 1504 may perform an RSSI measurement, an RSRP measurement, or the like. The measurement may be an L1 measurement (e.g., unfiltered in the time domain). The UE 1504 performs the measurement based on a first configuration type of the L1 CLI measurement resource and a second configuration type of the communication. Specific examples of performing the measurement are provided in connection with FIGS. 11, 12, and 13. In some aspects, the UE 1504 performs the measurement in accordance with a scheduling restriction. Specific examples of performing the measurement in accordance with the scheduling restriction are provided in connection with FIGS. 8 and 10. In some aspects, the UE 1504 performs the measurement or the communication in accordance with a cancellation timeline. Specific examples of performing the measurement, or the communication, in accordance with the cancellation timeline are provided in connection with FIGS. 9, 10, and 11.

FIG. 16 depicts a process flow 1600 for communications in a network between a network entity 1602 and a UE 1604. In some aspects, the network entity 1602 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 1604 may be an example of UE 104 depicted and described with respect to FIG. 1 or the UE 304 depicted and described with respect to FIG. 3. However, in other aspects, UE 1604 may be another type of wireless communications device and network entity 1602 may be another type of network entity or network node, such as those described herein. Note that any operations or signaling illustrated with dashed lines may indicate that that operation or signaling is an optional or alternative example.

At 1606, the network entity 1602 transmits, and the UE 1604 receives, a configuration of an L1 CLI measurement resource in an SBFD time resource. This configuration may use higher-layer signaling (e.g., for a semi-static configuration type of L1 CLI measurement resource) or dynamic signaling (e.g., for a dynamic configuration type of L1 CLI measurement resource). Examples of the L1 CLI measurement resource include L1 CLI measurement resource 815, L1 CLI measurement resource 915, L1 CLI measurement resource 1015, L1 CLI measurement resource 1115, L1 CLI measurement resource 1215, and L1 CLI measurement resource 1315. The L1 CLI measurement resource may have a semi-static configuration type (e.g., for a periodic L1 CLI measurement resource which is configured to occur according to a defined periodicity, or for a semi-persistent L1 CLI measurement resource which is configured semi-statically and then subsequently activated or deactivated via dynamic signaling) or a dynamic configuration type (e.g., for an aperiodic L1 CLI measurement resource which may be triggered by dynamic signaling).

At 1608, the network entity 1602 transmits, and the UE 1604 receives, an indication of a communication that conflicts with the L1 CLI measurement resource. The communication can be an uplink communication (e.g., in an uplink sub-band) or a downlink communication (e.g., in a downlink sub-band). In some aspects, the communication conflicts with the L1 CLI measurement resource because the communication overlaps with the L1 CLI measurement resource in the time domain. In some aspects, the communication conflicts with the L1 CLI measurement resource because the communication overlaps with the L1 CLI measurement resource in both the time domain and the frequency domain. In some aspects, the communication is in a same sub-band as the L1 CLI measurement resource. In some aspects, the communication is in a first sub-band and the L1 CLI measurement resource is in a second sub-band different than the first sub-band. Examples of the communication include communications 820, 920, 1020, 1120, 1220, and 1320.

At 1610, the UE 1604 performs the communication. For example, the UE 1604 may transmit the communication in an uplink sub-band. As another example, the UE 1604 may receive the communication in a downlink sub-band. The UE 1604 performs the communication at 1610 based on a first configuration type of the L1 CLI measurement resource and a second configuration type of the communication. Specific examples of performing the communication based on the first configuration type and the second configuration type are provided in connection with FIGS. 8, 10, and 13. In some aspects, the UE 1604 performs the communication in accordance with a cancellation timeline. For example, if the UE 1604 receives a configuration of the L1 CLI measurement resource within a defined time interval of the communication, the UE may drop the L1 CLI measurement resource and may perform the communication.

FIG. 17 depicts a process flow 1700 for communications in a network between a network entity 1702 and a UE 1704. In some aspects, the network entity 1702 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 1704 may be an example of UE 104 depicted and described with respect to FIG. 1 or the UE 304 depicted and described with respect to FIG. 3. However, in other aspects, UE 1704 may be another type of wireless communications device and network entity 1702 may be another type of network entity or network node, such as those described herein. Note that any operations or signaling illustrated with dashed lines may indicate that that operation or signaling is an optional or alternative example.

At 1706, the network entity 1702 transmits, and the UE 1704 receives, a configuration of an L1 CLI measurement resource in an SBFD time resource. This configuration may use higher-layer signaling (e.g., for a semi-static configuration type of L1 CLI measurement resource) or dynamic signaling (e.g., for a dynamic configuration type of L1 CLI measurement resource). Examples of the L1 CLI measurement resource include L1 CLI measurement resource 815, L1 CLI measurement resource 915, L1 CLI measurement resource 1015, L1 CLI measurement resource 1115, L1 CLI measurement resource 1215, and L1 CLI measurement resource 1315. The L1 CLI measurement resource may have a semi-static configuration type (e.g., for a periodic L1 CLI measurement resource which is configured to occur according to a defined periodicity, or for a semi-persistent L1 CLI measurement resource which is configured semi-statically and then subsequently activated or deactivated via dynamic signaling) or a dynamic configuration type (e.g., for an aperiodic L1 CLI measurement resource which may be triggered by dynamic signaling).

At 1708, the network entity 1702 transmits, and the UE 1704 receives, an indication of a communication that conflicts with the L1 CLI measurement resource. The communication can be an uplink communication (e.g., in an uplink sub-band) or a downlink communication (e.g., in a downlink sub-band). In some aspects, the communication conflicts with the L1 CLI measurement resource because the communication overlaps with the L1 CLI measurement resource in the time domain. In some aspects, the communication conflicts with the L1 CLI measurement resource because the communication overlaps with the L1 CLI measurement resource in both the time domain and the frequency domain. In some aspects, the communication is in a same sub-band as the L1 CLI measurement resource. In some aspects, the communication is in a first sub-band and the L1 CLI measurement resource is in a second sub-band different than the first sub-band. Examples of the communication include communications 820, 920, 1020, 1120, 1220, and 1320.

At 1710, the UE 1704 identifies an error case regarding the conflict. As a result of identifying the error case, the UE 1704 may perform a default behavior, such as dropping the communication, skipping the L1 CLI measurement, or a combination thereof. The UE 1704 identifies the error case based on a first configuration type of the L1 CLI measurement resource and a second configuration type of the communication. Specific examples of error cases are provided in connection with FIGS. 8-13. For example, the UE 1704 may identify an error case where a dynamically configured L1 CLI measurement resource conflicts with a dynamically configured communication.

FIG. 18 depicts a process flow 1800 for communications in a network between a network entity 1802 and a UE 1804. In some aspects, the network entity 1802 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 1804 may be an example of UE 104 depicted and described with respect to FIG. 1 or the UE 304 depicted and described with respect to FIG. 3. However, in other aspects, UE 1804 may be another type of wireless communications device and network entity 1802 may be another type of network entity or network node, such as those described herein. Note that any operations or signaling illustrated with dashed lines may indicate that that operation or signaling is an optional or alternative example.

At 1806, the network entity 1802 transmits, and the UE 1804 receives, a configuration of an L1 CLI measurement resource (e.g., L1 CLI measurement resource 1415) in an SBFD time resource. The L1 CLI measurement resource is in an uplink sub-band. This configuration may use higher-layer signaling (e.g., for a semi-static configuration type of L1 CLI measurement resource) or dynamic signaling (e.g., for a dynamic configuration type of L1 CLI measurement resource). The L1 CLI measurement resource may have a semi-static configuration type (e.g., for a periodic L1 CLI measurement resource which is configured to occur according to a defined periodicity, or for a semi-persistent L1 CLI measurement resource which is configured semi-statically and then subsequently activated or deactivated via dynamic signaling) or a dynamic configuration type (e.g., for an aperiodic L1 CLI measurement resource which may be triggered by dynamic signaling). The L1 CLI measurement resource conflicts with an SSB (e.g., SSB 1420) occurring in a downlink sub-band of the SBFD time resource. For example, the L1 CLI measurement resource may at least partially overlap the SSB in time.

At 1808, the UE 1804 performs an action based on whether the UE 1804 supports simultaneous reception of the SSB and measurement of the L1 CLI measurement resource. Examples of the action are provided below.

In some aspects, the action includes both performing a measurement on the L1 CLI measurement resource and receiving the SSB. For example, the UE 1804 may support simultaneous CLI measurement (e.g., CLI-RSSI or RSRP measurement) in the uplink sub-band and downlink reception (e.g., of the SSB). In such examples, the UE 1804 may perform a measurement on the L1 CLI measurement resource and receive the SSB. For example, the UE may perform the measurement on the L1 CLI measurement resource and receive the SSB if the L1 CLI measurement resource and the SSB have a same beam configuration (e.g., a same set of quasi co-location (QCL) parameters, such as a same QCL type D configuration). As another example, the UE may perform the measurement on the L1 CLI measurement resource and receive the SSB if a beam configuration is not configured for the L1 CLI measurement resource. As another example, the UE may perform the measurement on the L1 CLI measurement resource and receive the SSB if a beam configuration is not configured for the SSB.

In some aspects, the L1 CLI measurement resource may have a first beam configuration (e.g., set of QCL parameters) and the SSB may have a second beam configuration (e.g., set of QCL parameters) different than the first beam configuration. In such aspects, the UE 1804 may perform the measurement on the L1 CLI measurement resource and receive the SSB if the UE 1804 supports multi-beam reception (for example, if the UE 1804 has multiple antenna panels). If the UE 1804 does not support multi-beam reception, then the UE 1804 may receive the SSB and may drop the L1 CLI measurement resource (e.g., may not perform an L1 CLI measurement on the L1 CLI measurement resource).

In some aspects, the UE 1804 performs only one of the measurement on the L1 CLI measurement resource or receiving the SSB. For example, the UE 1804 may not support simultaneous CLI measurement in an uplink sub-band and downlink reception (e.g., of the SSB). In some aspects, the UE 1804 receives the SSB and drops the L1 CLI measurement resource (e.g., may not perform an L1 CLI measurement on the L1 CLI measurement resource). In some aspects, the UE 1804 identifies an error case. For example, the UE 1804 may not expect to be scheduled with an L1 CLI measurement resource (e.g., for CLI-RSSI measurement or SRS-RSRP measurement) in the uplink sub-band during a time resource (e.g., symbol) that includes an SSB.

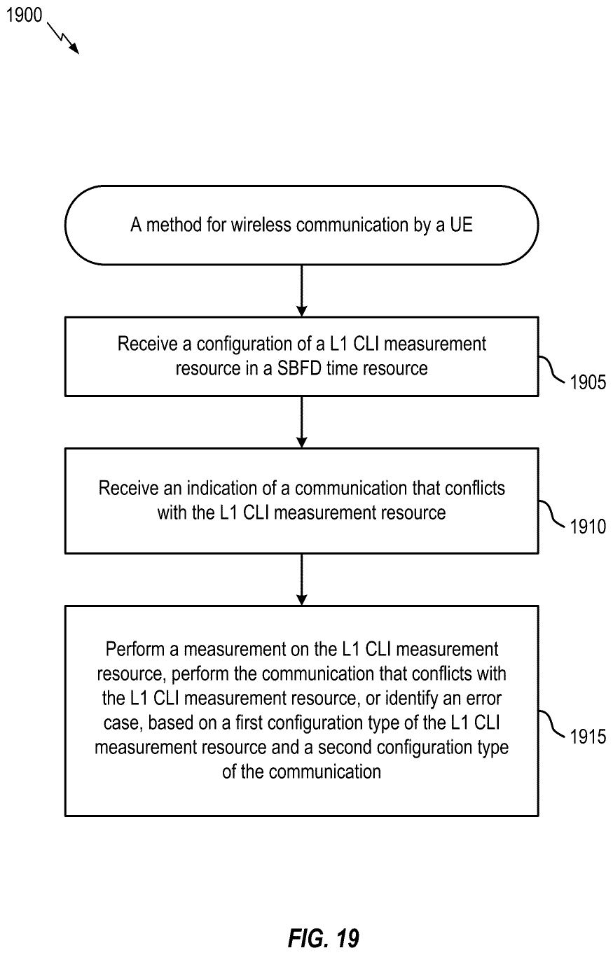

FIG. 19 shows a method 1900 for wireless communication by a UE, such as UE 104 of FIG. 1 or UE 304 of FIG. 3.

Method 1900 begins at block 1905 with receiving a configuration of a L1 CLI measurement resource in a SBFD time resource.

Method 1900 then proceeds to block 1910 with receiving an indication of a communication that conflicts with the L1 CLI measurement resource.

Method 1900 then proceeds to block 1915 with performing a measurement on the L1 CLI measurement resource, performing the communication that conflicts with the L1 CLI measurement resource, or identifying an error case, based on a first configuration type of the L1 CLI measurement resource and a second configuration type of the communication.

In some aspects, the L1 CLI measurement resource is a CLI received signal strength indicator resource or a CLI reference signal received power resource.

In some aspects, block 1915 includes identifying the error case.

In some aspects, block 1915 includes identifying the error case based on the first configuration type being a first dynamic configuration type and the second configuration type being a second dynamic configuration type.

In some aspects, the first configuration type is a first semi-static configuration type, the communication is an uplink communication, the L1 CLI measurement resource is in a downlink sub-band, and the second configuration type is a second semi-static configuration type.

In some aspects, the first configuration type is a first dynamic configuration type, the communication is an uplink communication, the L1 CLI measurement resource is in a downlink sub-band, and the second configuration type is a second dynamic configuration type.

In some aspects, the first configuration type is a first dynamic configuration type, the communication is an uplink communication, the L1 CLI measurement resource is in an uplink sub-band, and the second configuration type is a second dynamic configuration type.

In some aspects, the UE supports only one of the measurement or the communication at a given time, the first configuration type is a first dynamic configuration type, the communication is a downlink communication, and the second configuration type is a second dynamic configuration type.

In some aspects, the UE supports only one of the measurement or the communication at a given time, the first configuration type is a first semi-static configuration type, the communication is a downlink communication, and the second configuration type is a second semi-static configuration type.

In some aspects, block 1915 includes performing the communication.

In some aspects, the first configuration type is a semi-static configuration type, the communication is an uplink communication, the L1 CLI measurement resource is in a downlink sub-band, and the second configuration type is a dynamic configuration type.

In some aspects, the first configuration type is a semi-static configuration type, the communication is an uplink communication, the L1 CLI measurement resource is in an uplink sub-band, and the second configuration type is a dynamic configuration type.

In some aspects, the UE supports only one of the measurement or the communication at a given time, the first configuration type is a semi-static configuration type, the communication is a downlink communication, and the second configuration type is a dynamic configuration type.

In some aspects, the UE supports only one of the measurement or the communication at a given time, the first configuration type is a first semi-static configuration type, the communication is a downlink communication, and the second configuration type is a second semi-static configuration type.

In some aspects, block 1915 includes performing the measurement.

In some aspects, block 1915 includes performing the measurement in accordance with a scheduling restriction for the communication, wherein the first configuration type is a semi-static configuration type, the communication is an uplink communication, the L1 CLI measurement resource is in a downlink sub-band, and the second configuration type is a dynamic configuration type.

In some aspects, the scheduling restriction applies to an overlapped portion of the communication and a number of symbols preceding the communication.

In some aspects, block 1915 includes performing the measurement in accordance with a scheduling restriction for the communication, wherein the first configuration type is a first semi-static configuration type, the communication is an uplink communication, the L1 CLI measurement resource is in a downlink sub-band, and the second configuration type is a second semi-static configuration type.

In some aspects, block 1915 includes performing the measurement in accordance with a scheduling restriction, wherein the first configuration type is a semi-static configuration type, the communication is an uplink communication, the L1 CLI measurement resource is in an uplink sub-band, and the second configuration type is a dynamic configuration type.

In some aspects, block 1915 includes performing the measurement in accordance with a scheduling restriction, the first configuration type is a first semi-static configuration type, the communication is an uplink communication, the L1 CLI measurement resource is in an uplink sub-band, and the second configuration type is a second semi-static configuration type.

In some aspects, the UE supports only one of the measurement or the communication at a given time, the first configuration type is a semi-static configuration type, the communication is a downlink communication, and the second configuration type is a dynamic configuration type.

In some aspects, the UE supports only one of the measurement or the communication at a given time, the first configuration type is a dynamic configuration type, the communication is a downlink communication, and the second configuration type is a semi-static configuration type.

In some aspects, the UE supports only one of the measurement or the communication at a given time, the first configuration type is a first semi-static configuration type, the communication is a downlink communication, and the second configuration type is a second semi-static configuration type.

In some aspects, block 1915 includes performing one of the measurement or the communication in accordance with a cancellation timeline for the communication, wherein the first configuration type is a dynamic configuration type, the communication is an uplink communication, the L1 CLI measurement resource is in a downlink sub-band, and the second configuration type is a semi-static configuration type.

In some aspects, the cancellation timeline is satisfied for the communication and performing one of the measurement or the communication comprises performing the measurement.

In some aspects, the cancellation timeline is not satisfied for the communication and performing one of the measurement or the communication comprises performing the communication.

In some aspects, block 1915 includes performing one of the measurement or the communication in accordance with a cancellation timeline for the communication, wherein the first configuration type is a first semi-static configuration type, the communication is an uplink communication, the L1 CLI measurement resource is in an uplink sub-band, and the second configuration type is a second semi-static configuration type.

In some aspects, block 1915 includes performing one of the measurement or the communication in accordance with a cancellation timeline for the communication, wherein the first configuration type is a dynamic configuration type, the communication is an uplink communication, the L1 CLI measurement resource is in an uplink sub-band, and the second configuration type is a semi-static configuration type.

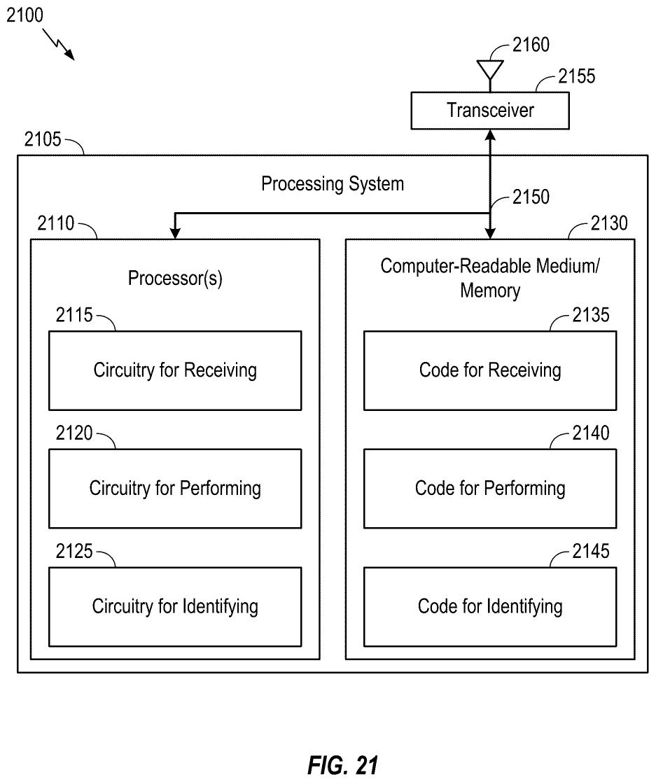

In some aspect, method 1900, or any aspect related to it, may be performed by an apparatus, such as communications device 2100 of FIG. 21, which includes various components operable, configured, or adapted to perform the method 1900. Communications device 2100 is described below in further detail.

Note that FIG. 19 is just one example of a method, and other methods including fewer, additional, or alternative operations are possible consistent with this disclosure.

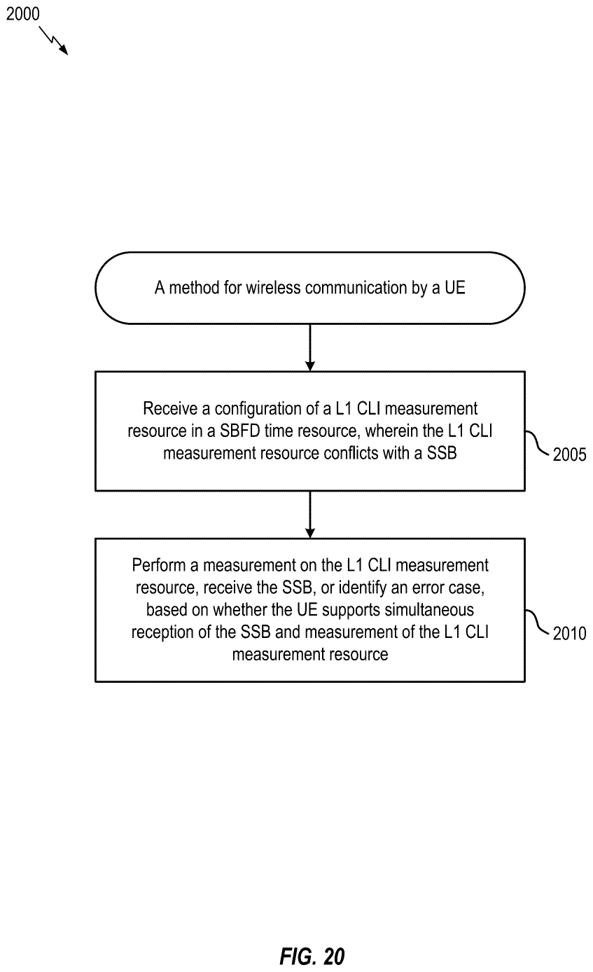

FIG. 20 shows a method 2000 for wireless communication by a UE, such as UE 104 of FIG. 1 or UE 304 of FIG. 3.

Method 2000 begins at block 2005 with receiving a configuration of a L1 CLI measurement resource in a SBFD time resource, wherein the L1 CLI measurement resource conflicts with a SSB.

Method 2000 then proceeds to block 2010 with performing a measurement on the L1 CLI measurement resource, receiving the SSB, or identifying an error case, based on whether the UE supports simultaneous reception of the SSB and measurement of the L1 CLI measurement resource.

In some aspects, block 2010 includes performing the measurement and receiving the SSB.

In some aspects, the UE supports the simultaneous reception of the SSB and measurement of the L1 CLI measurement resource.

In some aspects, performing the measurement and receiving the SSB is based on the SSB and the L1 CLI measurement resource having a same beam configuration.

In some aspects, performing the measurement and receiving the SSB is based on a beam configuration of the SSB being unconfigured.

In some aspects, the SSB is associated with a first beam configuration and the L1 CLI measurement resource is associated with a second beam configuration different than the first beam configuration, wherein the UE supports multi-beam reception, and wherein performing the measurement comprises performing the measurement in accordance with the second beam configuration, and wherein receiving the SSB comprises receiving the SSB in accordance with the first beam configuration.

In some aspects, block 2010 includes receiving the SSB.

In some aspects, the UE supports the simultaneous reception of the SSB and measurement of the L1 CLI measurement resource, wherein the SSB is associated with a first beam configuration and the L1 CLI measurement resource is associated with a second beam configuration different than the first beam configuration, and receiving the SSB comprises receiving the SSB in accordance with the first beam configuration.

In some aspects, the UE does not support the simultaneous reception of the SSB and measurement of the L1 CLI measurement resource.

In some aspects, the UE does not support the simultaneous reception of the SSB and measurement of the L1 CLI measurement resource, and wherein block 2010 includes identifying the error case.

In some aspect, method 2000, or any aspect related to it, may be performed by an apparatus, such as communications device 2100 of FIG. 21, which includes various components operable, configured, or adapted to perform the method 2000. Communications device 2100 is described below in further detail.

Note that FIG. 20 is just one example of a method, and other methods including fewer, additional, or alternative operations are possible consistent with this disclosure.

### Example Communications Devices

FIG. 21 depicts aspects of an example communications device 2100 configured for wireless communications. In some aspects, communications device 2100 is a user equipment, such as UE 104 described above with respect to FIG. 1 or UE 304 described with respect to FIG. 3.

The communications device 2100 includes a processing system 2105 coupled to a transceiver 2155 (e.g., a transmitter and/or a receiver). The transceiver 2155 is configured to transmit and receive signals for the communications device 2100 via an antenna 2160, such as the various signals as described herein. The processing system 2105 may be configured to perform processing functions for the communications device 2100, including processing signals received and/or to be transmitted by the communications device 2100.

The processing system 2105 includes one or more processors 2110 and a computer-readable medium/memory 2130. In various aspects, the one or more processors 2110 may be representative of the one or more processors 318 described with respect to FIG. 3. The one or more processors 2110 are coupled to a computer-readable medium/memory 2130 via a bus 2150. In some aspects, the computer-readable medium/memory 2130 may be representative of the one or more memories 320 described with respect to FIG. 3. The computer-readable medium/memory 2130 is a non-transitory computer-readable medium/memory. In certain aspects, the computer-readable medium/memory 2130 is configured to store instructions (e.g., computer-executable code), that when executed by the one or more processors 2110, cause the one or more processors 2110 to perform the method 1900 described with respect to FIG. 19, or any aspect related to it, including any operations described in relation to FIG. 19; and the method 2000 described with respect to FIG. 20, or any aspect related to it, including any operations described in relation to FIG. 20. Note that reference to a processor performing a function of communications device 2100 may include one or more processors performing that function of communications device 2100, such as in a distributed fashion.

In the depicted example, computer-readable medium/memory 2130 stores code (e.g., executable instructions), including code for receiving 2135, code for performing 2140, and code for identifying 2145. Processing of the code 2135-2145 may enable and cause the communications device 2100 to perform the method 1900 described with respect to FIG. 19, or any aspect related to it; and the method 2000 described with respect to FIG. 20, or any aspect related to it. For example, in some aspects, code for receiving 2135 includes code for receiving a configuration of a L1 CLI measurement resource in a SBFD time resource. In some aspects, code for receiving 2135 includes code for receiving an indication of a communication that conflicts with the L1 CLI measurement resource. In some aspects, code for performing 2140 includes code for performing a measurement on the L1 CLI measurement resource based on a first configuration type of the L1 CLI measurement resource and a second configuration type of the communication. In some aspects, code for performing 2140 includes code for performing the communication that conflicts with the L1 CLI measurement resource based on a first configuration type of the L1 CLI measurement resource and a second configuration type of the communication. In some aspects, code for identifying 2145 includes code for identifying an error case based on a first configuration type of the L1 CLI measurement resource and a second configuration type of the communication.

For example, in some aspects, code for receiving 2135 includes code for receiving a configuration of a L1 CLI measurement resource in a SBFD time resource, wherein the L1 CLI measurement resource conflicts with a SSB. In some aspects, code for performing 2140 includes code for performing a measurement on the L1 CLI measurement resource based on whether the UE supports simultaneous reception of the SSB and measurement of the L1 CLI measurement resource. In some aspects, code for receiving 2135 includes code for receiving the SSB based on whether the UE supports simultaneous reception of the SSB and measurement of the L1 CLI measurement resource. In some aspects, code for identifying 2145 includes code for identifying an error case based on whether the UE supports simultaneous reception of the SSB and measurement of the L1 CLI measurement resource.

The one or more processors 2110 include circuitry configured to implement (e.g., execute) the code stored in the computer-readable medium/memory 2130, including circuitry for receiving 2115, circuitry for performing 2120, and circuitry for identifying 2125. Processing with circuitry 2115-2125 may enable and cause the communications device 2100 to perform the method 1900 described with respect to FIG. 19, or any aspect related to it; and the method 2000 described with respect to FIG. 20, or any aspect related to it. For example, in some aspects, circuitry for receiving 2115 includes circuitry for receiving a configuration of a L1 CLI measurement resource in a SBFD time resource. In some aspects, circuitry for receiving 2115 includes circuitry for receiving an indication of a communication that conflicts with the L1 CLI measurement resource. In some aspects, circuitry for performing 2120 includes circuitry for performing a measurement on the L1 CLI measurement resource based on a first configuration type of the L1 CLI measurement resource and a second configuration type of the communication. In some aspects, circuitry for performing 2120 includes circuitry for performing the communication that conflicts with the L1 CLI measurement resource based on a first configuration type of the L1 CLI measurement resource and a second configuration type of the communication. In some aspects, circuitry for identifying 2125 includes circuitry for identifying an error case based on a first configuration type of the L1 CLI measurement resource and a second configuration type of the communication.

For example, in some aspects, circuitry for receiving 2115 includes circuitry for receiving a configuration of a L1 CLI measurement resource in a SBFD time resource, wherein the L1 CLI measurement resource conflicts with a SSB. In some aspects, circuitry for performing 2120 includes circuitry for performing a measurement on the L1 CLI measurement resource based on whether the UE supports simultaneous reception of the SSB and measurement of the L1 CLI measurement resource. In some aspects, circuitry for receiving 2115 includes circuitry for receiving the SSB based on whether the UE supports simultaneous reception of the SSB and measurement of the L1 CLI measurement resource. In some aspects, circuitry for identifying 2125 includes circuitry for identifying an error case based on whether the UE supports simultaneous reception of the SSB and measurement of the L1 CLI measurement resource.

More generally, means for communicating, transmitting, sending or outputting for transmission may include the one or more transceivers 324, one or more antenna 322 and/or processing system 316 of the UE 304 illustrated in FIG. 3, transceiver 2155 and/or antenna 2160 of the communications device 2100 in FIG. 21, and/or one or more processors 2110 of the communications device 2100 in FIG. 21. Means for communicating, receiving or obtaining may include the one or more transceivers 324, one or more antennas 322, and/or processing system 316 of the UE 304 illustrated in FIG. 3, transceiver 2155 and/or antenna 2160 of the communications device 2100 in FIG. 21, and/or one or more processors 2110 of the communications device 2100 in FIG. 21.

### Example Clauses

Implementation examples are described in the following numbered clauses:
Clause 1: A method for wireless communication by a UE, comprising: receiving a configuration of a L1 CLI measurement resource in a SBFD time resource; receiving an indication of a communication that conflicts with the L1 CLI measurement resource; and performing a measurement on the L1 CLI measurement resource, performing the communication that conflicts with the L1 CLI measurement resource, or identifying an error case, based on a first configuration type of the L1 CLI measurement resource and a second configuration type of the communication.
Clause 2: The method of Clause 1, wherein the L1 CLI measurement resource is a CLI received signal strength indicator resource or a CLI reference signal received power resource.
Clause 3: The method of any one of Clauses 1-2, wherein performing the measurement on the L1 CLI measurement resource, performing the communication that conflicts with the L1 CLI measurement resource, or identifying the error case comprises identifying the error case.
Clause 4: The method of Clause 3, wherein identifying the error case comprises identifying the error case based on the first configuration type being a first dynamic configuration type and the second configuration type being a second dynamic configuration type.
Clause 5: The method of Clause 3, wherein the first configuration type is a first semi-static configuration type, the communication is an uplink communication, the L1 CLI measurement resource is in a downlink sub-band, and the second configuration type is a second semi-static configuration type.
Clause 6: The method of Clause 3, wherein the first configuration type is a first dynamic configuration type, the communication is an uplink communication, the L1 CLI measurement resource is in a downlink sub-band, and the second configuration type is a second dynamic configuration type.
Clause 7: The method of Clause 3, wherein the first configuration type is a first dynamic configuration type, the communication is an uplink communication, the L1 CLI measurement resource is in an uplink sub-band, and the second configuration type is a second dynamic configuration type.
Clause 8: The method of Clause 3, wherein the UE supports only one of the measurement or the communication at a given time, the first configuration type is a first dynamic configuration type, the communication is a downlink communication, and the second configuration type is a second dynamic configuration type.
Clause 9: The method of Clause 3, wherein the UE supports only one of the measurement or the communication at a given time, the first configuration type is a first semi-static configuration type, the communication is a downlink communication, and the second configuration type is a second semi-static configuration type.
Clause 10: The method of any one of Clauses 1-9, wherein performing the measurement on the L1 CLI measurement resource, performing the communication that conflicts with the L1 CLI measurement resource, or identifying the error case comprises performing the communication.
Clause 11: The method of Clause 10, wherein the first configuration type is a semi-static configuration type, the communication is an uplink communication, the L1 CLI measurement resource is in a downlink sub-band, and the second configuration type is a dynamic configuration type.
Clause 12: The method of Clause 10, wherein the first configuration type is a semi-static configuration type, the communication is an uplink communication, the L1 CLI measurement resource is in an uplink sub-band, and the second configuration type is a dynamic configuration type.
Clause 13: The method of Clause 10, wherein the UE supports only one of the measurement or the communication at a given time, the first configuration type is a semi-static configuration type, the communication is a downlink communication, and the second configuration type is a dynamic configuration type.
Clause 14: The method of Clause 10, wherein the UE supports only one of the measurement or the communication at a given time, the first configuration type is a first semi-static configuration type, the communication is a downlink communication, and the second configuration type is a second semi-static configuration type.
Clause 15: The method of any one of Clauses 1-14, wherein performing the measurement on the L1 CLI measurement resource, performing the communication that conflicts with the L1 CLI measurement resource, or identifying the error case comprises performing the measurement.
Clause 16: The method of Clause 15, wherein performing the measurement comprises performing the measurement in accordance with a scheduling restriction for the communication, wherein the first configuration type is a semi-static configuration type, the communication is an uplink communication, the L1 CLI measurement resource is in a downlink sub-band, and the second configuration type is a dynamic configuration type.
Clause 17: The method of Clause 16, wherein the scheduling restriction applies to an overlapped portion of the communication and a number of symbols preceding the communication.
Clause 18: The method of Clause 15, wherein performing the measurement comprises performing the measurement in accordance with a scheduling restriction for the communication, wherein the first configuration type is a first semi-static configuration type, the communication is an uplink communication, the L1 CLI measurement resource is in a downlink sub-band, and the second configuration type is a second semi-static configuration type.
Clause 19: The method of Clause 15, wherein performing the measurement comprises performing the measurement in accordance with a scheduling restriction, wherein the first configuration type is a semi-static configuration type, the communication is an uplink communication, the L1 CLI measurement resource is in an uplink sub-band, and the second configuration type is a dynamic configuration type.
Clause 20: The method of Clause 15, wherein performing the measurement comprises performing the measurement in accordance with a scheduling restriction, the first configuration type is a first semi-static configuration type, the communication is an uplink communication, the L1 CLI measurement resource is in an uplink sub-band, and the second configuration type is a second semi-static configuration type.
Clause 21: The method of Clause 15, wherein the UE supports only one of the measurement or the communication at a given time, the first configuration type is a semi-static configuration type, the communication is a downlink communication, and the second configuration type is a dynamic configuration type.
Clause 22: The method of Clause 15, wherein the UE supports only one of the measurement or the communication at a given time, the first configuration type is a dynamic configuration type, the communication is a downlink communication, and the second configuration type is a semi-static configuration type.
Clause 23: The method of Clause 15, wherein the UE supports only one of the measurement or the communication at a given time, the first configuration type is a first semi-static configuration type, the communication is a downlink communication, and the second configuration type is a second semi-static configuration type.
Clause 24: The method of any one of Clauses 1-23, wherein performing the measurement on the L1 CLI measurement resource, performing the communication that conflicts with the L1 CLI measurement resource, or identifying the error case comprises performing one of the measurement or the communication in accordance with a cancellation timeline for the communication, wherein the first configuration type is a dynamic configuration type, the communication is an uplink communication, the L1 CLI measurement resource is in a downlink sub-band, and the second configuration type is a semi-static configuration type.
Clause 25: The method of Clause 24, wherein the cancellation timeline is satisfied for the communication and performing one of the measurement or the communication comprises performing the measurement.
Clause 26: The method of Clause 24, wherein the cancellation timeline is not satisfied for the communication and performing one of the measurement or the communication comprises performing the communication.
Clause 27: The method of any one of Clauses 1-26, wherein performing the measurement on the L1 CLI measurement resource, performing the communication that conflicts with the L1 CLI measurement resource, or identifying the error case comprises performing one of the measurement or the communication in accordance with a cancellation timeline for the communication, wherein the first configuration type is a first semi-static configuration type, the communication is an uplink communication, the L1 CLI measurement resource is in an uplink sub-band, and the second configuration type is a second semi-static configuration type.
Clause 28: The method of any one of Clauses 1-27, wherein performing the measurement on the L1 CLI measurement resource, performing the communication that conflicts with the L1 CLI measurement resource, or identifying the error case comprises performing one of the measurement or the communication in accordance with a cancellation timeline for the communication, wherein the first configuration type is a dynamic configuration type, the communication is an uplink communication, the L1 CLI measurement resource is in an uplink sub-band, and the second configuration type is a semi-static configuration type.
Clause 29: A method for wireless communication by a UE, comprising: receiving a configuration of a L1 CLI measurement resource in a SBFD time resource, wherein the L1 CLI measurement resource conflicts with a SSB; and performing a measurement on the L1 CLI measurement resource, receiving the SSB, or identifying an error case, based on whether the UE supports simultaneous reception of the SSB and measurement of the L1 CLI measurement resource.
Clause 30: The method of Clause 29, wherein performing the measurement on the L1 CLI measurement resource, receiving the SSB, or identifying the error case further comprises performing the measurement and receiving the SSB.
Clause 31: The method of Clause 30, wherein the UE supports the simultaneous reception of the SSB and measurement of the L1 CLI measurement resource.
Clause 32: The method of Clause 31, wherein performing the measurement and receiving the SSB is based on the SSB and the L1 CLI measurement resource having a same beam configuration.
Clause 33: The method of Clause 31, wherein performing the measurement and receiving the SSB is based on a beam configuration of the SSB being unconfigured.
Clause 34: The method of Clause 30, wherein the SSB is associated with a first beam configuration and the L1 CLI measurement resource is associated with a second beam configuration different than the first beam configuration, wherein the UE supports multi-beam reception, and wherein performing the measurement comprises performing the measurement in accordance with the second beam configuration, and wherein receiving the SSB comprises receiving the SSB in accordance with the first beam configuration.
Clause 35: The method of any one of Clauses 29-34, wherein performing the measurement on the L1 CLI measurement resource, receiving the SSB, or identifying the error case further comprises receiving the SSB.
Clause 36: The method of Clause 35, wherein the UE supports the simultaneous reception of the SSB and measurement of the L1 CLI measurement resource, wherein the SSB is associated with a first beam configuration and the L1 CLI measurement resource is associated with a second beam configuration different than the first beam configuration, and receiving the SSB comprises receiving the SSB in accordance with the first beam configuration.
Clause 37: The method of Clause 35, wherein the UE does not support the simultaneous reception of the SSB and measurement of the L1 CLI measurement resource.
Clause 38: The method of any one of Clauses 29-37, wherein the UE does not support the simultaneous reception of the SSB and measurement of the L1 CLI measurement resource, and wherein performing the measurement on the L1 CLI measurement resource, receiving the SSB, or identifying the error case further comprises identifying the error case.
Clause 39: One or more apparatuses, comprising: one or more memories comprising executable instructions; and one or more processors configured to execute the executable instructions and cause the one or more apparatuses to perform a method in accordance with any one of Clauses 1-38.
Clause 40: One or more apparatuses configured for wireless communications, comprising: one or more memories; and one or more processors, coupled to the one or more memories, configured to cause the one or more apparatuses to perform a method in accordance with any one of Clauses 1-38.
Clause 41: One or more apparatuses configured for wireless communications, comprising: one or more memories; and one or more processors, coupled to the one or more memories, configured to perform a method in accordance with any one of Clauses 1-38.
Clause 42: One or more apparatuses, comprising means for performing a method in accordance with any one of Clauses 1-38.
Clause 43: One or more non-transitory computer-readable media comprising executable instructions that, when executed by one or more processors of one or more apparatuses, cause the one or more apparatuses to perform a method in accordance with any one of Clauses 1-38.
Clause 44: One or more computer program products embodied on one or more computer-readable storage media comprising code for performing a method in accordance with any one of Clauses 1-38.
Clause 45: One or more apparatuses configured for wireless communications, comprising: a processing system that includes one or more processors and one or more memories coupled with the one or more processors, the processing system configured to cause the one or more apparatuses to perform a method in accordance with any one of Clauses 1-38.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for wireless communications, comprising a processing system that includes one or more processors and one or more memories coupled with the one or more processors, the processing system configured to cause a user equipment (UE) to:
receive a configuration of a layer 1 (L1) cross-link interference (CLI) measurement resource in a sub-band full duplex (SBFD) time resource;
receive an indication of a communication that conflicts with the L1 CLI measurement resource; and
perform a measurement on the L1 CLI measurement resource, performing the communication that conflicts with the L1 CLI measurement resource, or identifying an error case, based on a first configuration type of the L1 CLI measurement resource and a second configuration type of the communication.

2. The apparatus of claim 1, wherein the L1 CLI measurement resource is a CLI received signal strength indicator resource or a CLI reference signal received power resource.

3. The apparatus of claim 1, wherein to cause the UE to perform the measurement on the L1 CLI measurement resource, perform the communication that conflicts with the L1 CLI measurement resource, or identify the error case, the processing system is configured to cause the UE to identify the error case.

4. The apparatus of claim 3, wherein to cause the UE to identify the error case, the processing system is configured to cause the UE to identify the error case based on the first configuration type being a first dynamic configuration type and the second configuration type being a second dynamic configuration type.

5. The apparatus of claim 1, wherein to cause the UE to perform the measurement on the L1 CLI measurement resource, perform the communication that conflicts with the L1 CLI measurement resource, or identify the error case, the processing system is configured to cause the UE to perform the communication.

6. The apparatus of claim 5, wherein the first configuration type is a semi-static configuration type, the communication is an uplink communication, the L1 CLI measurement resource is in a downlink sub-band, and the second configuration type is a dynamic configuration type.

7. The apparatus of claim 5, wherein the first configuration type is a semi-static configuration type, the communication is an uplink communication, the L1 CLI measurement resource is in an uplink sub-band, and the second configuration type is a dynamic configuration type.

8. The apparatus of claim 5, wherein the UE supports only one of the measurement or the communication at a given time, the first configuration type is a semi-static configuration type, the communication is a downlink communication, and the second configuration type is a dynamic configuration type.

9. The apparatus of claim 5, wherein the UE supports only one of the measurement or the communication at a given time, the first configuration type is a first semi-static configuration type, the communication is a downlink communication, and the second configuration type is a second semi-static configuration type.

10. The apparatus of claim 1, wherein to cause the UE to perform the measurement on the L1 CLI measurement resource, perform the communication that conflicts with the L1 CLI measurement resource, or identify the error case, the processing system is configured to cause the UE to perform the measurement.

11. The apparatus of claim 10, wherein to cause the UE to perform the measurement, the processing system is configured to cause the UE to perform the measurement in accordance with a scheduling restriction for the communication, wherein the first configuration type is a semi-static configuration type, the communication is an uplink communication, the L1 CLI measurement resource is in a downlink sub-band, and the second configuration type is a dynamic configuration type.

12. The apparatus of claim 11, wherein the scheduling restriction applies to an overlapped portion of the communication and a number of symbols preceding the communication.

13. The apparatus of claim 10, wherein to cause the UE to perform the measurement, the processing system is configured to cause the UE to perform the measurement in accordance with a scheduling restriction for the communication, wherein the first configuration type is a first semi-static configuration type, the communication is an uplink communication, the L1 CLI measurement resource is in a downlink sub-band, and the second configuration type is a second semi-static configuration type.

14. The apparatus of claim 10, wherein to cause the UE to perform the measurement, the processing system is configured to cause the UE to perform the measurement in accordance with a scheduling restriction, wherein the first configuration type is a semi-static configuration type, the communication is an uplink communication, the L1 CLI measurement resource is in an uplink sub-band, and the second configuration type is a dynamic configuration type.

15. The apparatus of claim 10, wherein to cause the UE to perform the measurement, the processing system is configured to cause the UE to perform the measurement in accordance with a scheduling restriction, the first configuration type is a first semi-static configuration type, the communication is an uplink communication, the L1 CLI measurement resource is in an uplink sub-band, and the second configuration type is a second semi-static configuration type.

16. The apparatus of claim 10, wherein the UE supports only one of the measurement or the communication at a given time, the first configuration type is a semi-static configuration type, the communication is a downlink communication, and the second configuration type is a dynamic configuration type.

17. The apparatus of claim 10, wherein the UE supports only one of the measurement or the communication at a given time, the first configuration type is a dynamic configuration type, the communication is a downlink communication, and the second configuration type is a semi-static configuration type.

18. The apparatus of claim 10, wherein the UE supports only one of the measurement or the communication at a given time, the first configuration type is a first semi-static configuration type, the communication is a downlink communication, and the second configuration type is a second semi-static configuration type.

19. A method for wireless communication by a user equipment (UE), comprising:
receiving a configuration of a layer 1 (L1) cross-link interference (CLI) measurement resource in a sub-band full duplex (SBFD) time resource, wherein the L1 CLI measurement resource conflicts with a synchronization signal block (SSB); and
performing a measurement on the L1 CLI measurement resource, receiving the SSB, or identifying an error case, based on whether the UE supports simultaneous reception of the SSB and measurement of the L1 CLI measurement resource.

20. A method for wireless communication by a user equipment (UE), comprising:
receiving a configuration of a layer 1 (L1) cross-link interference (CLI) measurement resource in a sub-band full duplex (SBFD) time resource;
receiving an indication of a communication that conflicts with the L1 CLI measurement resource; and
performing a measurement on the L1 CLI measurement resource, performing the communication that conflicts with the L1 CLI measurement resource, or identifying an error case, based on a first configuration type of the L1 CLI measurement resource and a second configuration type of the communication.
